(19) United States
(12) Patent Application Publication
(10) Pub. No.: US 2025/0188711 A1
(43) Pub. Date: Jun. 12, 2025

(54) MONITORING DEVICE FOR TRACKING A WEAR ELEMENT; SYSTEMS AND METHODS

(71) Applicant: UNIVERSIDAD DE SANTIAGO DE CHILE, Santiago (CL)

(72) Inventors: Álvaro Patricio ESPEJO PIÑA, Santiago (CL); Carlos Javier EUGENIO HERRERA, Santiago (CL); Dora Rosa ALTBIR DRULLINSKY, Santiago (CL); Omar Andrés DAUD ALBASINI, Santiago (CL); Sebastián Andrés SEPÚLVEDA VÁSQUEZ, Santiago (CL); Matías Bernardo TARGARONA HERRERA, Santiago (CL); Gabriel Esteban FUENTES AMPUERO, Santiago (CL)

(21) Appl. No.: 19/054,799

(22) Filed: Feb. 15, 2025

Related U.S. Application Data
(63) Continuation of application No. 18/551,362, filed on Sep. 19, 2023.

(30) Foreign Application Priority Data
Mar. 19, 2021 (CL) 688-2021

(51) Int. Cl. E02F 9/26; E02F 9/28

(52) U.S. Cl. CPC E02F 9/26; E02F 9/28

(57) ABSTRACT

The present invention relates to an electronic monitoring device for autonomously tracking, detecting and reporting the installation/re-installation and detachment/uninstallation of a wear element (GET) and a GET clamping element on an earthmoving machine. The device is installed in a cylindrical cavity in the GET. The electronic monitoring device and GET have an identifier code for maintaining continuous wireless communication despite the highly metallic surrounding environment, even reporting during transit. The electronic monitoring device manages its energy according to its operating status (“Standby”, “Installed Device”, “Installed GET” or “Detached GET”), and it has separate upper and lower twin sensing means, which detect the installation/re-installation and detachment/uninstallation through magnetic hysteresis curves, changes in amplitude of the standing wave in the transmission line of a resonant antenna, or changes in amplitude or phase of an RLC circuit with thermal normalisation, or changes in the self-frequency of a self-resonant RLC circuit; and an outer protective casing.

This application is a continuation of U.S. application Ser. No. 18/551,362, filed 19 Sep. 2023, which is a National Stage of International Application No. PCT/CL2022/050019, filed 1 Mar. 2022, which claims priority to and the benefit of Chilean Application No. 688-2021, filed 19 Mar. 2021, the entireties of which are hereby incorporated herein by reference.

### FIELD OF THE INVENTION

The present invention relates to an electronic device, monitoring system and method for autonomously tracking, detecting and reporting its installation/re-installation and detachment/removal on a ground engaging tool (GET), as well as the installation/re-installation and detachment/removal status of a GET with electronic monitoring device with respect to a clamping element in an earth moving machine, wherein said GET may be selected from teeth, adapters or protectors, shrouds, sidebar protectors or teeth holders, among others. Said earth moving machine may be selected from a mining shovel, mining loading equipment, among others. The monitoring of the GET is performed autonomously at least from the installation of the electronic monitoring device in the GET until it completes its useful life cycle or until it cannot be detected because its power source is depleted, or the GET could not be located after detachment or lost wireless communication with the network. Monitoring is performed by managing the power consumption according to 4 main operational states of the GET lifecycle (“Standby” state, “Device Installed” state, “GET Installed” state or “GET Detached” state). And additionally, the electronic monitoring device also detects its installation/re-installation and detachment/removal on a GET, as well as the installation/re-installation and detachment/removal of the GET with electronic monitoring device with respect to a clamping element in an earth moving machine by means of magnetic hysteresis curves; amplitude changes in the standing wave in the transmission line of a resonant antenna, changes in the amplitude and phase of a thermally normalized RLC circuit, and by changes in the self-frequency of a self-resonant RLC circuit. The electronic monitoring device is installed inside a GET, in a cylindrical housing cavity in the GET, and maintains continuous wireless communication with the communication network despite the surrounding metallic environment.

### BACKGROUND

A GET (Ground Engaging Tools) is a ground engaging tool installed in earth moving machines, e.g. mining shovels, which is intended to be the first contact between the machinery and the ground. These ground engaging tools are designed to protect other more valuable components and must be replaced from time to time due to their accelerated wear. However, there are events where they become completely detached and are mixed with the ore. When this event occurs and the ground engaging tool is not separated from the ore early, it can reach the primary crusher and jam or block it, leading to high economic losses due to unscheduled stoppage, damage to the crushing equipment and putting at risk the lives of the personnel who must remove the GET, for example, from the primary crusher.

To detect the detachment of a GET, cameras or portals with electronic tag readers, such as RFID technology devices, are generally used. However, these technologies or technical solutions fail to effectively detect the detachment, due to the shielding caused by dust, dirt, rocks or ore during the operation of mining equipment, and with it, the noise or distortion of the data or information received from the images of cameras or RFID readers. To overcome this challenge, image-based technologies focus on developing robust image processing software that recognizes detachment, yet they report a large number of false positives (detachment) and negatives (no detachment), and the high processing times slow the generation of GET detachment or non-detachment reports. RFID-based technology, on the other hand, requires the installation of portals through which the loading equipment must pass in order for the detection of the GET detachment to occur and, therefore, the detection is delayed in time with respect to the moment in which the detachment actually occurred.

There are also electronic devices that are related to sensors installed in the locks or pins that hold the tooth with the adapter. However, if the tooth becomes detached from the adapter, the lock may or may not remain attached to the tooth, and if it is not attached to the tooth and falls away from it, the location of the detached tooth will not be known, nor will its detachment be detected. In particular, among the patent documents addressing the technical problem of detecting the detachment of a GET, it is possible to mention U.S. Pat. No. 10,787,792B2 (ESCO Corp.) which relates to a system for monitoring a ground engaging tool of an excavating machine with an electronic monitoring device, a wireless communication device transmitting data collected by the electronic device; a remote device receiving data from the wireless communication device; a programmable logic device processing data received by the remote device providing information from the monitored ground engaging tool that relates to the shedding thereof. It may include a display interface that displays real-time information about the ground engaging tool shedding status. Such a ground engaging tool may be a digging tooth. The programmable logic device information includes one or more of identifying the ground engaging tool, establishing its wear level, estimating its remaining useful life, establishing whether it is in use or has been discarded, establishing its performance, recording and reporting impact events received. It may also have a “lock” system that secures the monitoring device to the ground engaging tool, and which comprises a collar and a threaded pin with a recess for holding the monitoring device, optionally other elements that seek to secure the monitoring device to the ground engaging tool.

U.S. Pat. No. 10,011,975B2 (ESCO GROUP LLC) relates to a system for monitoring a ground engaging tool of an excavating machine, comprising a base attached to the machine with a nose that projects forward and is subjected to wear and receives a tooth tip and a padlock securing it to the base, and an electronic monitoring device and a “lock” or padlock. The electronic monitoring device identifies the ground engaging tool and a wireless communication device communicates information from the ground engaging tool to a remote device. A control device supports the electronic device, the communication device and the battery. The ground engaging tool information can be: its identification, presence, wear level, performance, among others. It may also include a camera to obtain an image of the ground engaging tool that can be displayed on a screen or processed alone or together with the information received from the monitoring device to generate ground engaging tool information. The base and ground engaging tool may be secured to a first mining machine, and the remote device may be secured to a second mining machine, including a haul truck with a truck tray, the remote device being secured to the truck tray. Alternatively, the remote device may be secured to a station overlapping a roadway along which transport trucks travel.

US20160237640A1 (Esco Group LLC) relates to a monitoring system for an excavating machine, comprising a monitoring tool including a mobile vehicle that can move independently at different positions of the machine and an electronic device on a mobile vehicle for remotely detecting a characteristic of the ground engaging tool. The mobile vehicle may be an unmanned aerial vehicle (UAV) or a remotely or autonomously operated vehicle. The electronic device is a surface characterization device, including an optical camera; a device that creates a point cloud representation of at least a portion of the product; or an electronic device that captures a two-dimensional or three-dimensional representation of at least a portion of the wear item to determine the level of wear, estimate the amount of material excavated, among other features. It may also include a global position system device; and a processor for determining wear rates of the ground engaging tool from data collected from the electronic device.

U.S. Pat. No. 10,612,213B2 (Esco Group LLC) relates to a monitoring system comprising a ground engaging tool monitoring device and a wireless communication device for transmitting data collected by said electronic monitoring device; at least one remote device for receiving the data wirelessly; and at least one programmable logic device for processing the data related to the ground engaging tool. Said programmable logic device based on the received data may determine or define one or more of: a wear rate, replacement schedule, soil penetrability, digging speed, etc. Said remote device can determine the schedules for digging. The database that includes information from the work site, allowing to determine one or more of: terrain geology, soil fragmentation, abrasiveness, hardness or georeferencing, among others. The monitoring device can detect the wear of the ground engaging tool or the impact on the ground engaging tool upon contact with the soil, the duration of the load, the digging cycles, among others. The monitoring device can detect the stress on the ground engaging tool upon contact with the soil, applied loads, number of passes, among others. The programmable logic device can perform an inventory or determine fuel consumption from the collected data. The ground engaging tool is attached to the digging edge of the excavating machine.

U.S. Pat. No. 10,633,831B2 (Esco Group LLC) relates to a monitoring system for a ground engaging tool secured to an excavating machine, comprising an electronic monitoring device; a wireless communication device for transmitting data collected by the electronic monitoring device during use of the ground engaging tool; at least one remote device for receiving the data wirelessly; and at least one programmable logic device for processing the received data and providing information related to the ground engaging tool. The ground engaging tool can be secured to the excavating machine by means of an elastomeric padlock with a removable cover to prevent the accumulation of soil particles and a collar with a threaded pin with a recess. The ground engaging tool information includes the ground engaging tool identification, the state of detachment, level of wear, an estimate of the remaining service life, whether it is in use, its performance, among others. It may include a display interface for providing real-time information about the ground engaging tool detachment, wherein said ground engaging tool may be a digging tooth.

U.S. Pat. No. 10,633,832B2 (Esco Group LLC) relates to a monitoring system comprising a ground engaging tool attached to an excavating machine; a monitoring device attached to the ground engaging tool that enables its monitoring and wireless transmission of ground engaging tool data/information; a remote device that receives such information from the monitoring device; a database containing excavation site information; and a programmable logic device for processing both the ground engaging tool and excavation site information, and thereby estimating the remaining useful life of the ground engaging tool. The excavation site information may include one or more of: material fragmentation level, abrasiveness, hardness, site geology. It may also include a GPS device secured to the ground engaging tool and the excavating machine to detect the location of the excavation site and wirelessly transmit such information to the remote device. The programmable logic device processes both the location, ground engaging tool and excavation site information to estimate the remaining life of the ground engaging tool. The database may further include wear rate information of the ground engaging tool and the programmable logic device processes the wear rate information, ground engaging tool information, and excavation location information to determine the estimated remaining useful life of the ground engaging tool. The ground engaging tool can be attached to the digging edge of a bucket and can be a digging tooth.

U.S. Pat. No. 10,760,247B2 (Esco Group LLC) relates to a monitoring system for a ground engaging tool, comprising: a monitoring device for wirelessly transmitting ground engaging tool information including its identity and detachment when installed on an excavating machine; a first remote device that receives the ground engaging tool identity information as it is moved from the site where it was manufactured to the excavation site where it will be used; a second remote device that receives ground engaging tool information as it is attached to the excavating machine; and at least one programmable logic device for processing the aforementioned identity information, which allows tracking the shipping progress and processing the data/information received from the ground engaging tool. A wireless communication device transmits the identity and ground engaging tool information, which is located in a cavity of the ground-engaging tool that is attached to the base located on the digging edge of the bucket of the excavating machine. The programmable logic device provides information about the detachment of the ground engaging tool. Also, it may include a display interface to provide real-time information about the ground engaging tool. The programmable logic device provides information about the level of wear of the ground engaging tool, an estimate of its remaining life, whether it is “in use”, its performance, among others. The ground engaging tool may include a lock located in an opening that secures the ground engaging tool to the excavating machine. The monitoring device is secured to said padlock comprising a collar secured in the opening, and a pin threaded into the collar to secure the ground engaging tool to the excavating machine, and wherein the pin includes a cavity housing the monitoring device. The ground engaging tool may be a digging tooth, a spike configured to attach to a bracket attached to a drum of the excavating machine, an edge of a digging bucket, among others. The ground engaging tool may also comprise an opening and a lifting eye secured in the opening, and wherein the control device is secured. Alternatively, the ground engaging tool may comprise an opening with removable cover securing the monitoring device.

U.S. Pat. No. 10,669,698B2 (Esco Group LLC) relates to a monitoring system for a ground engaging tool removably secured by a padlock to an excavating machine, comprising: a control device contained within a cavity of the padlock that allows controlling at least one feature of the ground engaging tool, and a wireless communication device that transmits data received from the control device. A remote device receives the data transmitted by the wireless communication device and a programmable logic device processes the data providing information related to the ground engaging tool. The padlock may include a collar secured in an opening with a threaded pin with a recess that secures the ground engaging tool to the excavating machine. The ground engaging tool may be configured to attach to the digging edge of a bucket. Information provided by the programmable logic device allows for identification of the ground engaging tool, its looseness, level of wear, an estimate of its remaining life, among others. It can also include a human display interface to provide real-time information on the ground engaging tool detachment. The padlock has a rigid component for contacting the ground-engaging tool and the base, and defines a recess that is sized and shaped to receive a tool while the monitoring device is contained in the recess. The padlock can include a socket located within the recess and includes the monitoring device.

WO2012116408A1 (Encore Automation Pty Ltd) relates to a system for detecting the loss of a ground engaging tool of an excavating machine, comprising a radio frequency identification tag securable to the ground engaging tool, and one or more tag reading stations each including a radio frequency identification tag reader. The radio frequency tag may be an active radio frequency identification tag. It may also comprise a monitoring station, a tag reader station including a wireless transceiver such that the monitoring station and the tag reader station are capable of communicating with each other. The monitoring station also includes a server that is capable of communicating with the wireless transceiver of the monitoring station and the radio frequency identification tag reader of the tag reading station is capable of communicating with the wireless transceiver of that tag reading station. The tag reading station may be a tag reading station mounted on a machine, and may also include a computer that is capable of communicating with the radio frequency identification tag reader of the tag reading station that is mounted on the excavating machine. The tag reading station can be a fixed position tag reading station, which can also include a computer that can communicate with the radio frequency identification tag reader of the fixed position tag reading station. The tag reading station may also be a m-tag reading station, which may also include a computer that may communicate with the RFID tag reader of the fixed position tag reading station. The tag reading station can also be a personal mobile tag reading station. The radio frequency identification tag for the excavator ground engaging tool comprises a protective housing, an electronic circuit contained in the housing, wherein the tag may be an active radio frequency identification tag. The protective housing may include a container and a lid for covering an opening at its end. The tag seals an interface between the lid and the container. The protective housing is cylindrical, and may be made of a polymer. The electronic circuit may include a circuit board and an epoxy resin coating on the circuit board. The radio frequency identification tag also comprises a protective insert to protect the circuit within the housing, and also comprises a cover for the circuit.

US20190284784A1 (Sandvik Intellectual Property AB) relates to a system for monitoring detachment of a ground engaging tool of an excavating machine, comprising a ground engaging tool mountable and detachable in a mounting region of an excavating machine; a proximity sensor provided on the ground engaging tool and configured to detect proximity of the ground engaging tool with respect to the mounting region; and a wireless transmitter provided on the ground engaging tool that transmits proximity data to a receiver located remote from the ground engaging tool. The proximity sensor may include one of or a combination of: an inductor component; a capacitor component; and a proximity sensor component. It may include an electronic tag for locating the proximity sensor that may include one or a combination of: a printed circuit board; a processor; a data storage unit; a transceiver; and an antenna. The transceiver may include a radio frequency transceiver and/or a Bluetooth transceiver. It may further comprise: an actuator having a printed circuit board, a processor, and a transceiver, the actuator being configured for wireless communication with the electronic tag, which is encapsulated within the housing or encapsulation material. The receiver may include a printed circuit board, a processor, a transceiver, and a data storage unit; and also a user interface having a display screen for outputting proximity data or information based on the proximity data. The mounting region may be the leading edge of a digging bucket of an excavating machine. The ground engaging tool may include one of or a combination of: a temperature sensor; a wear status sensor of the ground engaging tool; an accelerometer; and a voltage sensor. The tags may be RFID tags.

CN202809691U (Beijing Zhongkuang Huawo Technology CO LTD) relates to a wireless positioning monitoring device for electric shovel tooth comprising a radio frequency signal transmitting unit installed on the shovel for a real-time output radio frequency signal, and a unit that receives and processes the radio frequency signal, status inspections are performed based on the data from the signal transmitting unit, and generates tooth loss alarm reports and the display unit is used to alarm, in real time, a sound or light is generated to indicate tooth loss. In addition, the device comprises a wireless positioning receiver chip that is used to detect the installed tooth when the original signal is lost.

US20160376771A1 (Caterpillar Inc.) relates to a system for measuring the wear performance of a ground engaging tool of an excavating machine, comprising: a first ultrasonic sensor within the ground engaging tool configured to send pulses in a direction substantially perpendicular to the leading edge of the ground engaging tool; a second ultrasonic sensor within the ground engaging tool configured to send pulses in a direction having an offset angle with respect to perpendicular to the leading edge of the ground engaging tool; a wireless communication element associated with the first and second ultrasonic sensors and configured to send signals from the ultrasonic sensors; and a controller configured to receive the signals from the communication element and determine the wear behavior of the ground engaging tool based on the received signals. A Further, the system may comprise a battery associated with the ultrasonic sensors and the wireless communication element, wherein the battery, the ultrasonic sensors, and the wireless communication element are mounted together within the ground-engaging tool, or in a package, and the package is within a cavity formed in the ground-engaging tool. The system may further include a display associated with the controller and configured to display an image representing the current wear performance. The first and second ultrasonic sensors may be arranged substantially parallel to each other, with the first ultrasonic sensor configured to receive pulse echoes sent by the second ultrasonic sensor, and with the second ultrasonic sensor configured to receive pulse echoes sent by the first ultrasonic sensor. The controller may be located adjacent to an operator station on board the machine, and is configured to generate data indicative of a wear pattern of the ground-engaging tool. The controller may be configured to perform a triangulation calculation, based on data generated from signals from the first and second ultrasonic sensors, to determine a wear pattern of the leading edge of the ground engaging tool; generate data indicative of its wear rate and determine that wear rate; report data on its performance; compare data generated from signals received from the communication element with reference data to create a notification signal, among others. The notification signal may be an audible or visual notification. The visual signal comprises an image depicting the wear behavior of the ground engaging tool. The system may include at least a third ultrasonic sensor within the ground engaging tool for sending pulses in a direction at an angle with respect to the leading edge of the ground engaging tool that is different from the directions of the pulses sent by the first and second ultrasonic sensors, and tool related to said system.

However, there remains in the state of the art, the need for a device, system and method for monitoring ground engaging tools (GET) of an earthmoving machine, which allows autonomously to detect its installation inside a GET, the installation/re-installation of GET in an earthmoving machine and its detachment/removal when the machine is in operation, manage its power consumption, establish wireless communication in highly metallic environments and perform detection based on 4 main operating states, selected from: 1) “Standby” state, i.e., electronic monitoring device not installed; 2) “Device Installed” state, i.e., electronic monitoring device installed on GET; 3) “GET Installed” state, i.e., GET with electronic monitoring device installed on earthmoving machine; or 4) “GET Detached” state, i.e., GET with electronic monitoring device detached from earthmoving machine, in operation.

The autonomy in wireless communication, frees it from the use of complementary portals for GET sensing since in the present electronic monitoring device has wireless communication from the GET-holding element interface, wherein said GET-holding element interface is selected from tooth-adapter, adapter-lip, shroud-lip, sidebar protector-bucket, among others. Similarly, by managing power consumption, the electronic monitoring device essentially does not require recharging or replacement of power supply means. Likewise, being autonomous, the present electronic monitoring device does not require any type of human or assisted intervention for its activation.

Furthermore, the present electronic monitoring device has a protective housing to isolate its internal components from the high temperatures that the GET can reach when installed in an earth moving machine, in operation, and optionally can be housed in a housing means to secure it in a cavity in the GET, making the installation of the present electronic monitoring device independent of the size and geometry of said cavity.

This electronic monitoring device provides information and establishes permanent communication despite the highly metallic environment in which it is located. The present electronic monitoring device has independent twin sensing means, located: one, at the top of the device, and the other, at the bottom, which can alternate their operation/activation according to the operating status of the life cycle of the GET. The electronic monitoring device detects its installation/re-installation and detachment/removal on a GET, as well as the installation/re-installation and detachment/removal of the GET with electronic monitoring device installed on a clamping element of an earth moving machine, by one of: magnetic hysteresis curves; amplitude changes in the standing wave in the transmission line of a resonant antenna; changes in the amplitude or phase of an RLC circuit; or changes in the self-frequency of an autoranging RLC circuit. Thus, the installation/re-installation or detachment/removal of the GET with electronic monitoring device on an earthmoving machine can be determined with respect to its fastening element. A system and method of monitoring the GET throughout its life cycle is also disclosed.

### BRIEF DESCRIPTION OF FIGURES

FIG. 1 Shows a first embodiment of the outer housing means (1, body without cover) of the present electronic monitoring device (2), and snap-in receiving means (3, vertical rectangular slot) receiving the fin-like clamping means (4A) of the outer housing (2) of the present electronic monitoring device.

FIG. 2 Shows a first embodiment of the outer housing (2) of the present electronic monitoring device, the fin-like clamping means (4A) thereof, the upper locking means (5) receiving to the housing means cover (1), lateral support means (6, semi-cylindrical projections).

FIG. 3 Shows a side view of the first mode of the outer housing (2) of the present electronic monitoring device.

FIGS. 4A to 4C Show a side view (FIG. 4A), a bottom plan view (FIG. 4B) and a top perspective view (FIG. 4C) of a first mode of lid (7) for a first and second mode of the housing means (1) of the present electronic monitoring device, wherein the first mode of lid (7) shows a central transverse recess assisting the closure of the lid (7) in the housing means (1).

FIGS. 5A to 5C Show a top perspective view of the disassembled (FIG. 5A), assembled (FIG. 5B) and closed (FIG. 5C) electronic monitoring device of the first mode of the present electronic monitoring device.

FIGS. 6A to 6D show a top plan view (FIG. 6A) and a top perspective view (6B) of a second embodiment for the housing means (1) and a perspective view and a side view of a second embodiment of the outer housing (2), wherein the fin-like clamping means (4B) project from the inner surface of the housing means and the snap-on receiving means (3) are located in the housing, this being the reverse of the first embodiment wherein the fin-type clamping means (4A) project from the outer surface of the outer housing (2) and the socket receiving means (3) are located in the housing means (1).

FIGS. 7A to 7D Show a side view (FIG. 7A), bottom plan (7B) and right and left side perspective (FIGS. 7C and 7D) of a fourth mode of cover (7) for the outer housing (2).

FIG. 8 Shows a fourth mode of the electronic monitoring device comprising the outer housing (2) without the housing means (1).

FIGS. 9A-9G Show third mode of cover for the housing means (1), wherein the closure is by spinning instead of snapping. FIG. 9A the housing means (1) having thread (12c), at its upper inner end. FIGS. 9B and 9C show the outer housing (2). FIGS. 9D to 9F show a side view of a second embodiment of the cap (7) having thread, a top perspective view and a plan view thereof. FIG. 9G shows a perspective view of the present disassembled electronic monitoring device.

FIG. 10 shows a front cutaway view of the GET (10) in a first cavity mode (11) receiving the present electronic monitoring device.

FIGS. 11A and 11B Show a perspective view of the GET (10) in a first cavity mode (11) receiving the present electronic monitoring device.

FIGS. 12A and 12B Show a perspective view of the GET (10) in a second cavity mode (11) receiving the present electronic monitoring device.

FIG. 13 Shows a diagrammatic cross-section of the present electronic monitoring device (C) located in the cavity (11), highly metallic environment surrounded by the GET (B) and clamping element (A), with the twin sensing means located, one at the top of the device (D), and the other, at the bottom of the device (F), and in between, the programmable components and battery (E).

FIG. 14 Shows a schematic of a wireless communication mode of the GET when it is being moved.

FIG. 15 Shows a schematic of a wireless communication mode of a detached GET (10).

FIG. 16 Shows a schematic of the detection of a GET (10) in hold.

FIG. 17 Shows a schematic of wireless communication from the electronic device to the “Gateway” and from the “Gateway” to the cloud, and from the cloud to the network server (top of FIG. 17) and from multiple electronic devices to multiple “Gateways”, from the multiple “Gateways” to a single “Gateway” and from that single “Gateway” to the network server.

FIG. 18 Shows a flowchart for the useful cycle life of a GET.

FIG. 19 Shows a flowchart of the changes of states of the electronic monitoring device.

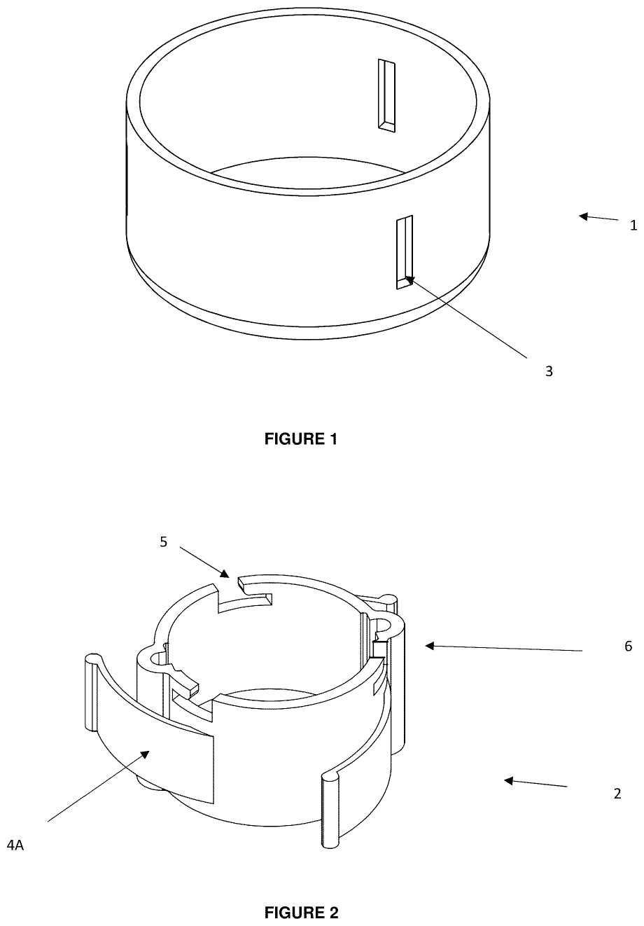

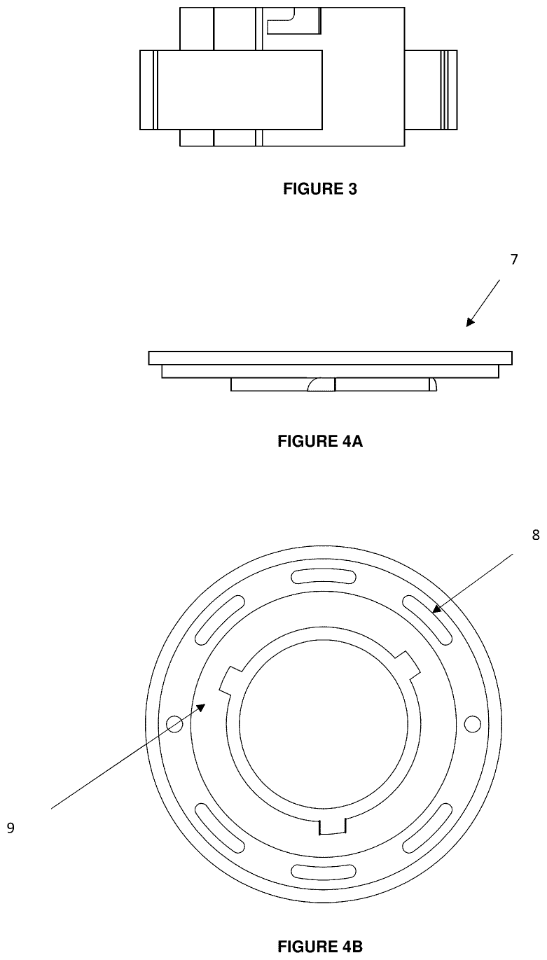

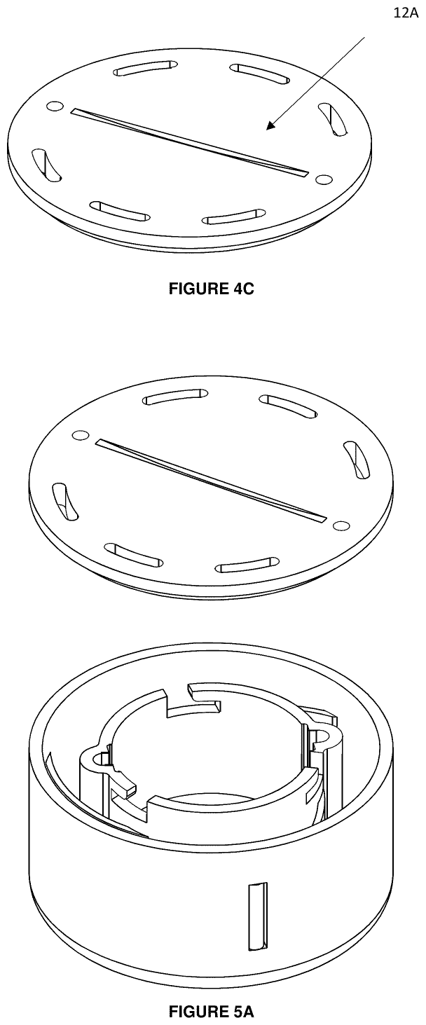

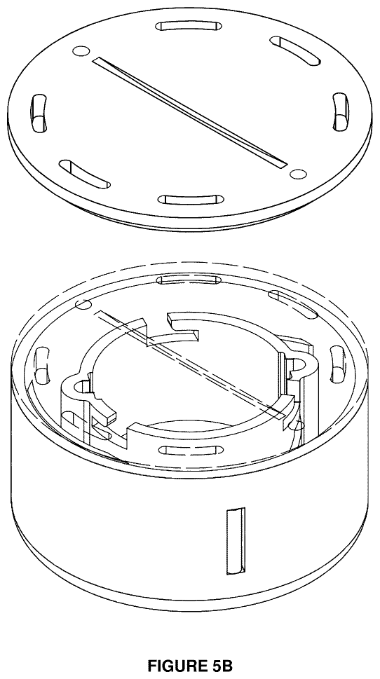

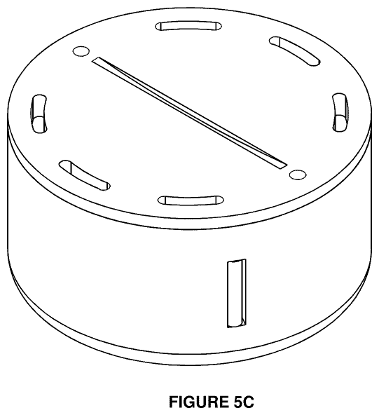

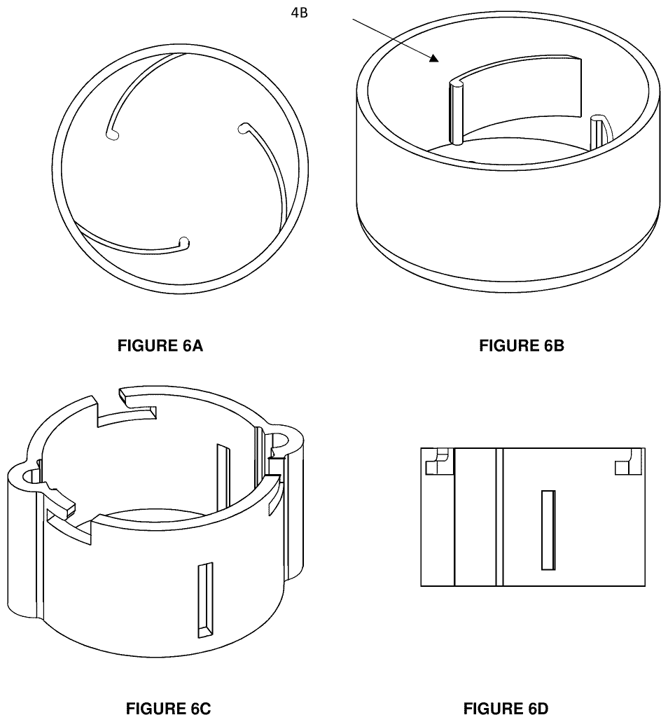

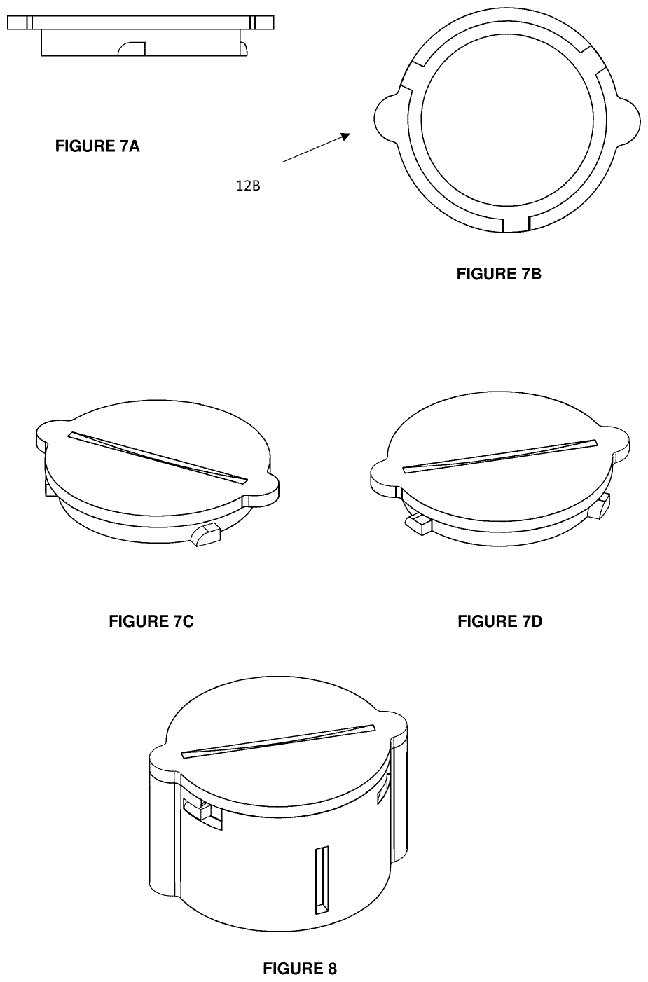

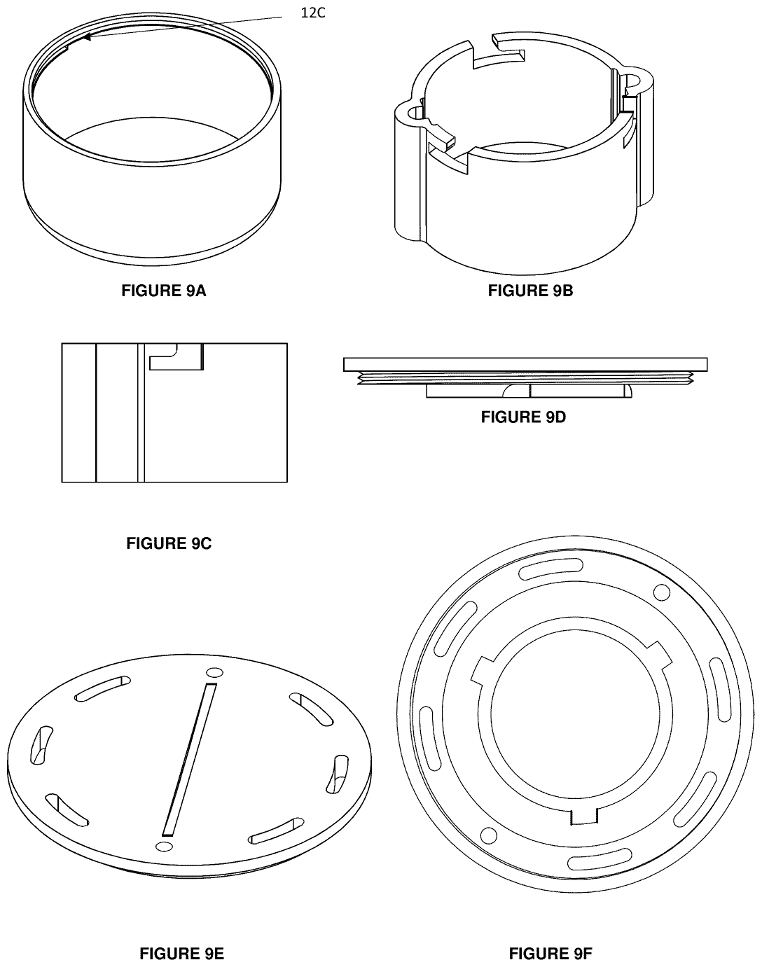

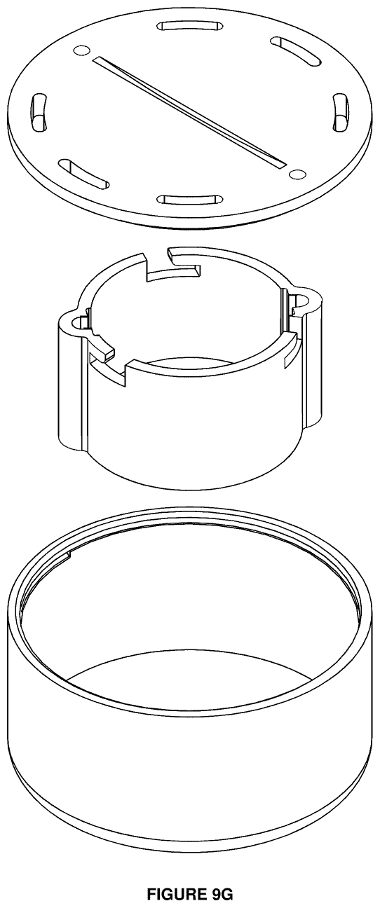

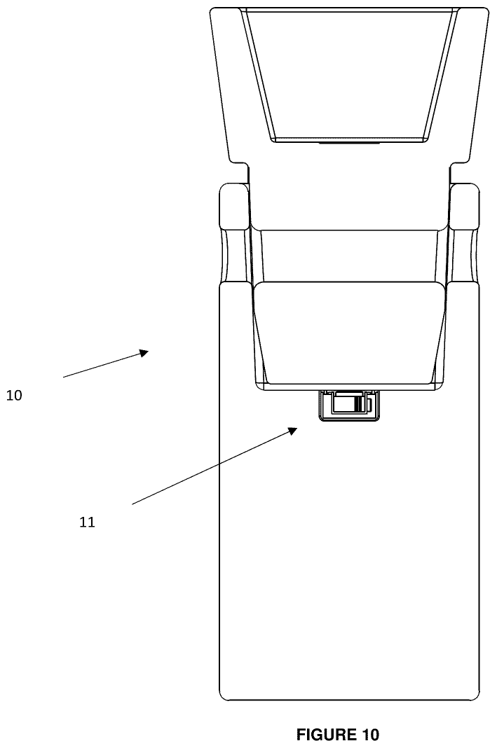

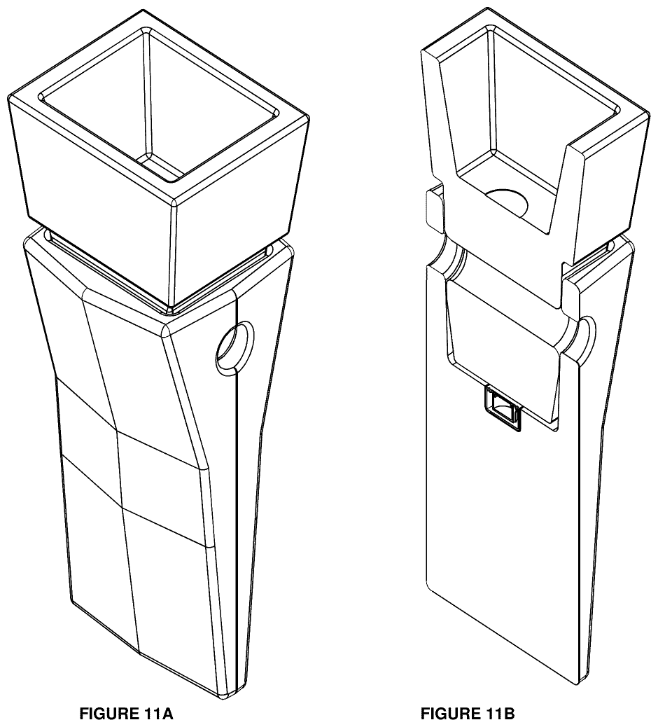

### DESCRIPTION OF THE INVENTION

The present electronic monitoring device that allows to autonomously track, detect and report its installation/re-installation and detachment/removal, in a ground engaging tool (GET) as well as the installation/reinstallation and detachment/removal status of a GET with an electronic monitoring device with respect to a clamping element in an earth-moving machine, in operation, where said electronic monitoring device is installed/located in a cylindrical housing cavity (11) in the GET. Likewise, this electronic monitoring device autonomously reports its location when the GET moves, and also autonomously detects and reports the installation/re-installation and detachment/removal of the GET. Said electronic monitoring device, said GET or both, have an identifying code or number that is recognized in the wireless communication network. The electronic monitoring device allows recognition that the GET removal is temporary (maintenance/repair/replacement) or permanent (discard/not recovered). Said removal is definitive when the wireless communication network does not detect a change in the “Detached State” of the GET, either because the power source was depleted, the GET could not be located after detachment, or it lost communication with the network. Both the temporary and permanent removal of the GET is autonomously recorded and updated in the GET inventory in a database. Additionally, the electronic monitoring device autonomously reports GET detachment. The electronic monitoring device also allows power management, wireless communication and detection based on 4 main operating states: “Standby” state, “Device Installed” state, “GET Installed” state or “GET Detached” state.

The autonomy in wireless communication, frees it from the use of complementary portals for GET detection since in the present electronic monitoring device has wireless communication from the GET-holding element interface, where said GET-holding element interface is selected from a tooth-adapter, adapter-lip, shroud-lip, sidebar protector-bucket interface, among others. Similarly, by managing power consumption, the electronic monitoring device essentially does not require recharging or changing the power supply means. Likewise, once the power supply is installed, the present electronic monitoring device does not require any human or assisted intervention to change its operating states autonomously.

Hereinafter, unless otherwise specified, the following meanings should be considered:

Said “GET” or ground engaging tool, may be selected from one or more teeth, adapters or protectors, shrouds, sidebar protectors or teeth holders, among others.

Said “GET” or clamping element may be selected from an adapter, bucket lip, bucket, among others. In some embodiments, a clamping element may also be considered as a GET, because it also serves the function of protecting the lip and the bucket. A particular case is the function of the adapter, which holds the tooth, and further protects the lip from wear, impacts and shocks.

Said an “earth moving machine” can be selected from a mining shovel, a mining loading equipment, among others.

Said 4 States of Operation are defined as: 1) State “Standby” or simply “Standby”, i.e., electronic monitoring device, with power source installed, not installed in GET; 2) State “Device Installed” or simply “Device Installed”, i.e., electronic monitoring device installed/re-installed in GET; 3) “GET Installed” or simply “GET Installed” status, i.e., GET with electronic monitoring device installed/installed on a fastening element on an earthmoving machine; or 4) Status “GET Detached” or simply “GET Detached”, i.e. GET with electronic monitoring device detached/detached from a clamping element on an earthmoving machine, in operation or with its useful life cycle ended, or until battery exhausted, or GET was not recovered after detachment or GET lost wireless communication with the network.

The present electronic monitoring device is designed to provide information of its installation/re-installation and detachment/removal status on a GET, as well as the installation/re-installation and detachment/removal status of a GET with electronic monitoring device with respect to a clamping element on an earthmoving machine, despite the surrounding highly metallic environment. The present electronic monitoring device has twin, independent sensing means, located, one at the top, and the other, at the bottom, which can alternate in their operation/activation according to the state of operation and detects its installation/re-installation and detachment/removal, in a GET, as well as the installation/re-installation and detachment/removal of the GET with electronic monitoring device, in an earth moving machine, by one of: magnetic hysteresis curves; amplitude changes in the standing wave in the transmission line of a resonant antenna or changes in the amplitude and phase of a thermally normalized RLC circuit, or changes in the self-frequency of a self-resonant RLC circuit, being also able to communicate wirelessly with the outside despite the highly shielded environments by metallic elements, in which it is located. The electronic monitoring device is designed to protect the internal components from the high temperatures that can reach a GET installed in an earth moving machine, in operation, having a protective casing. Optionally, the present electronic monitoring device may be housed in a housing means for securing it in a cavity (11) in the GET, making the installation of the present electronic monitoring device independent of the size and geometry of said cavity.

Further, a related monitoring system and method is disclosed, which detects the installation status of an electronic monitoring device in a GET, of a GET in an earthmoving machine or both, and the detachment of the GET in an operating earthmoving machine, managing the power consumption of the electronic monitoring device, and establishing wireless communication and detecting based on 4 main operating states: “Standby”, “Device Installed”, “GET Installed”, “GET Installed” or “GET Detached”.

The detection of an event of installation/re-installation or detachment/removal of the electronic monitoring device in the GET or of the GET with electronic monitoring device with respect to a clamping element in an earthmoving machine is based on the generation of low frequency magnetic fields for the creation of hysteresis curves; or amplitude changes in the standing wave in the transmission line of a resonant antenna; or changes in the amplitude and phase of an RLC circuit with thermal normalization; or according to changes in the self-frequency of a self-resonant RLC circuit.

It is worth mentioning that, in general, GET can be manufactured by forging or casting. In both cases, it is not possible that, in the manufacture of multiple GET, the cavities for the installation of a sensor are all perfectly uniform in size and shape. In fact, they vary slightly from one another, on the order of millimeters. Such slight differences in the cavities may cause, if the electronic monitoring device is installed directly in the cavity, that it is tightly or tightly housed in some cavities, while it is loosely or loosely housed in other cavities, and in the latter case, the electronic monitoring device is facilitated to fall due to the permanent vibrations of the earth moving machine carrying the GET and the shocks it receives during operation. Likewise, such a difference may generate significant alterations in the measurements of the electronic monitoring device due to the propagation of errors in time, which influences the effectiveness of the detection of the GET detachment by preventing the establishment of reliable and systematic thresholds for the detection signals.

Said electronic monitoring device may alert of the detachment status of the GET by activating or enabling the generation of visual signals, audible signals, or both. Said means emitting visual signals, auditory signals or both are selected from sirens, horns, loudspeakers, loudspeaker, computer screens or wireless devices with digital display with access to a telephone or satellite network and the Internet, among others. These visual signals are selected from text notes, images or both. Said visual alarms, audible alarms or both, are generated or sent, autonomously, either to the operator of the earthmoving machine or at a monitoring center with a server connected to the network and which is located at the place of operation of the earthmoving machine or both. For example, sending an audible signal and a message with a text notification that is displayed on the screen of a computer, cell phone, Tablet, among others. In this way, the earthmoving machine is prevented from continuing to operate, and the search and recovery of the GET in the ore is made possible.

As already mentioned, the present electronic monitoring device allows the management of energy consumption according to the GET operation status, thus ensuring a low energy consumption, which allows it to reach a useful life period of even up to 2 years, counted from its installation in the GET. The periodicity of data/information transmission is described in Table 1 below:

TABLE 1

| | | | | GET with | |
|---|---|---|---|---|---|
| | | | Electronic | electronic | |
| | | Electronic | monitoring | monitoring | GET |
| Status of the | Periodicity¹ in | monitoring | device with | device with | Detaching/ |
| electronic monitoring | the transmission | device with | power supply | power supply | removal of |
| device in stages of | of data to the | installed | installed in | on earthmoving | earthmoving |
| the GET life cycle | server | power source | GET | machine | machine |
| Standby² | Very low | Active | No active | No active | No active |
| Device Installed³ | Low | No active | Activo | No active | No active |
| GET Installed⁴ | High | No active | No activo | Active | No active |
| GET Detached⁵ | High | No active | No active | No active | Active |

¹Data transmission periodicity: Very low, from 1 hour to 24 hours. Low, from 3 minutes to 1 hour. High, from 0.1 seconds to 3 minutes.
²Status “Standby” = electronic monitoring device, with power source installed, not installed in GET, e.g., may be in storage or on the way to be installed in GET,
³Status “Installed Device” = electronic monitoring device installed in GET, for example, may be stored or on the way to be installed in the earthmoving machine,
⁴Status “GET Installed” = GET with electronic monitoring device in installation/re-installation on a clamping element of an earthmoving machine, which may be waiting to start operation or on an earthmoving machine operating with new or recovered/reinstalled/replaced GET,
⁵GET Detached” status = GET with electronic monitoring device detached/detached from a fixture on an earthmoving machine, or with its life cycle ended, or even battery depleted, or GET was not recovered after detachment or GET lost wireless communication with the network.

Thus, the periodicity of data transmission to the server is kept very low prior to the installation of an electronic monitoring device in a GET, and low prior to the installation of a GET with electronic monitoring device on a clamping element of an earthmoving machine, e.g., a loading equipment, and becomes high when the GET with electronic monitoring device is installed on a clamping element of an earthmoving machine, e.g., a loading equipment, or when it has become detached. When the GET is installed on a clamping element of such an earthmoving machine, e.g., a loading equipment, and the latter is in operation, it is sought to effectively detect the detachment of the GET to stop such an earthmoving machine, e.g., loading equipment, early, if the detachment actually occurs, so that the detached GET can be searched for and retrieved, in the ore, and optionally, re-install it. The early shutdown of the equipment prevents the detached GET from moving to other units or operational/productive areas of the mine, such as the primary crusher.

Table 2 below shows the management of the wireless communication protocols of this electronic monitoring device, according to the 4 operation states mentioned above, activating in a differentiated way, a communication protocol selected from Bluetooth Low Energy, Lora, Lora Ranging Engine Packet, GFSK or FLRC.

TABLE 2
Wireless communication protocols and activation according
to the lifecycle states of the electronic monitoring device

| | | State: | State: | State: |
|---|---|---|---|---|
| Protocols | State: | “Device | “GET | “GET |
| Communication | “Standby” | Installed” | Installed” | Detached” |
| Bluetooth Low | X | X | | |
| Energy | | | | |
| Lora (2450 MHz) | X | X | X | X |
| Lora Ranging | | | | X |
| Engine | | | | |
| Packet | | | | |
| GFSK | | | X | X |
| FLRC | | | X | X |

X = active, where State “Standby”, State “Device Installed”, State “GET Installed”, y State “GET Detached” are as defined for Table 1.

In the “Standby”, “Device Installed” or “GET Installed” states, one of the wireless communication protocols chosen from Table 2 is used and indicated as active by the symbol “X”. While for the “GET Detached” status, a combination of at least two of the 4 wireless communication protocols marked as “active” in Table 2 is used in parallel, thus increasing the chances of detecting an alarm signal from the GET and, optionally, facilitating the search for a detached GET, facilitate the search for a detached GET by activating said communication protocol, together with the “Lora Ranging Engine Packet” protocol that allows detecting the distance between said detached GET and an operator with a module for scanning said wireless signal, thus preventing said detected detached GET from being moved together with the extracted mineral.

As mentioned before, the present electronic monitoring device has twin sensing means that, depending on their location inside the protective outer casing (2), in its upper or lower part, are activated, according to the Operating State, see Table 3.

TABLE 3

| Activation of the twin | | State: | State: | State: |
|---|---|---|---|---|
| sensing means according | State: | “DDevice | “GET | “GET |
| to their location | “Standby” | Installed” | Installed” | Detached” |
| First twin of sensing | X¹ | X² | Does not | Does not |
| medium in lower | | | measure | measure |
| location⁴ | | | | |
| Second twin of sensing | Does not | X² | X³ | X³ |
| medium in upper | measure | | | |
| location⁵ | | | | |

¹measurement rate of at least once every 60 minutes,
²measurement rate of at least once every 30 minutes,
³measurement rate of at least once every 10 seconds,
⁴Bottom location, corresponds to a location where the sensing means are located at the inside and bottom of the protective outer casing (2), and are facing in front of or directed or pointing towards the bottom of the GET cavity (11);
⁵Top location, corresponds to a location where the sensing means are located to the inside and at the top of the outer housing (2); the sensing means are in contact with or in close proximity and directed/pointing to the GET attachment element, such location being selected proximate and directed/pointing to the GET attachment element from: 1) proximate and aimed/targeting at the tooth adapter if the electronic monitoring device is installed on a tooth of the earthmoving machine; 2) proximate and aimed/targeting at the lip if the electronic monitoring device is installed on an adapter of a tooth or in-between tooth of the earthmoving machine; 3) proximal and aimed/targeting at the bucket if the electronic monitoring device is installed on a guard of the earthmoving machine, which may preferably be a shovel or loading equipment, where State “Standby”, State “Device Installed”, State “GET Installed”, and State “GET Detached” are as defined for Table 1.

Thus, in the “Standby” or “Device Installed” states, it is the first sensing media twin, located at the bottom, that performs the measurements. While the second sensing media twin, located at the top, performs the measurements in the “Device Installed”, “GET Installed” or “GET Detached” states.

The present electronic device for monitoring a ground engaging tool (GET) of earthmoving machine, tracks, detects and autonomously reports its installation inside a GET, the installation of the GET in an earthmoving machine and the detachment thereof when the machine is in operation, comprises an outer casing (2) inside which are housed a plurality of electronic and programmable components, which confer to it the functionalities of: 1) monitoring either of installation/re-installation and detachment/removal, and additionally location of the GET, by means of magnetic or electromagnetic sensing means in environments highly shielded by metallic elements, which can be obtained from independent sensing means located in different positions, which are activated according to the operating state of the useful life cycle of the GET, 2) management of energy consumption according to 4 defined operating states of the useful life cycle of the GET. GET, 3) wireless communication according to a protocol associated with the state of the electronic monitoring device according to 4 defined operating states of the useful life cycle detected for the GET, and 4) monitoring during the useful life cycle.

In a first, second and third embodiment, the present electronic monitoring device comprises a protective outer casing (2), inside which a series of electronic and programmable components are housed, which is received by an external housing means (1), which in turn is located within a cavity (11) in the GET (10), allowing the safe accommodation of the electronic monitoring device in the GET. Said external housing means (1) standardizes the installation of this electronic monitoring device, since if it is considered that the cavities (11) of the GET may have dimensions and shapes slightly different from each other, it would be the outer protective housing (2) of the electronic monitoring device that should be adapted/adapted to the cavity, whereas with the presence of the outer housing means (1), the present electronic monitoring device is simply housed inside the outer housing means (1), which in turn, is previously installed in the cavity (11) of the GET, adapting itself to its dimensions and shapes.

In a fourth, simpler embodiment, the present electronic monitoring device comprises a protective outer housing (2), inside which the electronic and programmable components are housed, and is installed directly in the cavity (11) of the GET.

In all embodiments, the protective outer housing (2) of the present device is essentially cylindrical, hollowed out on the inside, and low in height. While the outer housing means (1) has a cylindrical shape, hollowed out on the inside, and is slightly larger in diameter and height compared to the protective outer housing (2), which allows it to freely receive and hold the latter, on the inside.

In the first and second embodiments, the protective outer housing (2) of the present electronic monitoring device is removably attached to the outer housing means (1). While in the first modality, the protective outer housing (2) has at least 2 fin-shaped clamping means (4A) projecting vertically, tangentially and equidistantly from the outer mantle of the protective outer housing (2) that allow it to be attached to the housing means (1) outside. In a second embodiment, the outer housing means (1) has at least 2 fin-shaped clamping means (4B) projecting vertically, tangentially and equidistantly from the inner mantle of the outer housing means (1) that enable it to be attached to the protective outer housing (2).

In a third embodiment, the outer housing means (1) is removably joined to the protective outer housing (2) by threaded attachment, wherein the upper inner surface of the housing means (1) is removably joined by threaded attachment to the upper wide end of the removable cover (7) and the protective outer housing (2) is removably joined by snap-locking means (9) to the lower narrow end of the removable cover (7).

In the first and second embodiment of the present electronic monitoring device, the protective outer housing (2) is secured within the housing means (1) outside by means of said at least 2 fin-shaped clamping means (4) which are joined in reversible connection in snap-locking receiving means, preferably, in the form of a vertical rectangular groove (3), located either on the housing means (1) outer or on the protective outer casing (2), this according to whether said at least 2 fin-shaped clamping means (4) project from the outer mantle of the protective outer casing (2) or from the inner mantle of the housing means (1) outer, respectively. Said fin-shaped clamping means (4) may have different thicknesses, lengths and heights as required in consideration of the dimensions of the outer housing means (1).

Said socket closure receiving means are selected from at least 3 socket closure recesses, preferably “L” shaped (5), and which receive, in removable union, the socket closure means (9) of the removable lid (7), in the first, second and third modalities, or simply receive the socket closure means of a removable lid of smaller size in the fourth modality.

The removable lid (7) of the outer housing means (1) has, in any of its modalities, on its inner surface, at least 2 lower ventilation means (8) that allow the entry of cooler air from the outside, to the inside of the outer housing means (1), and in turn, the exit of hot air from the inside of the housing means (1) outside, towards the outside of the same, thus avoiding that the temperature rises both inside the housing means (1) outside and inside the outer casing (2) of the present electronic monitoring device.

Likewise, in the first, second and third modes, the removable cover (7) may comprise at least one gripping means (12A) that facilitates the removable closure and opening of the outer housing means (1). In the fourth mode, that is, in the mode of direct installation of the outer housing on the GET, the removable cover repeats the same gripping feature and additionally features a pair of tabs (12B) to assist reversible closure by engagement with the outer housing (2). In the third embodiment there is only a threaded fastener between the removable cover (7) and the inner upper edge (12C) of the housing means and does not feature gripping means (4A and 4B) as in the first and second embodiments.

The material of the protective outer casing (2), the housing means (1) and the removable cover (7) are selected from a polymeric, co-polymeric material or derivatives thereof or fiberglass, wherein said materials are selected from Teflon, polyaramid, nylon, polyurethane, polystyrene, among others.

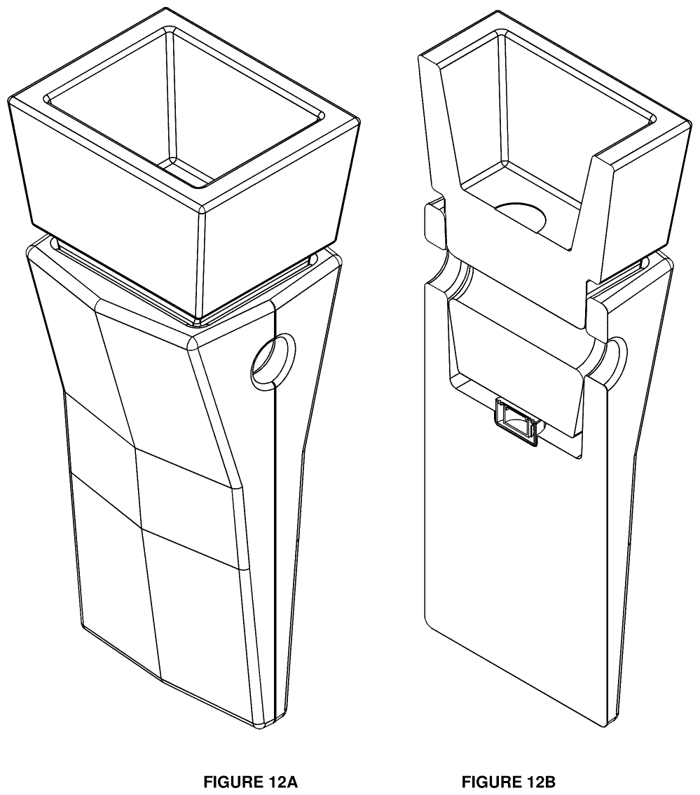

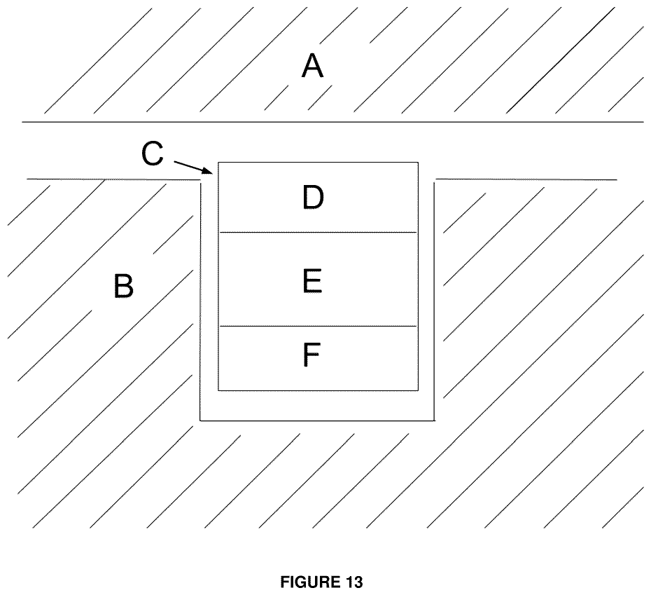

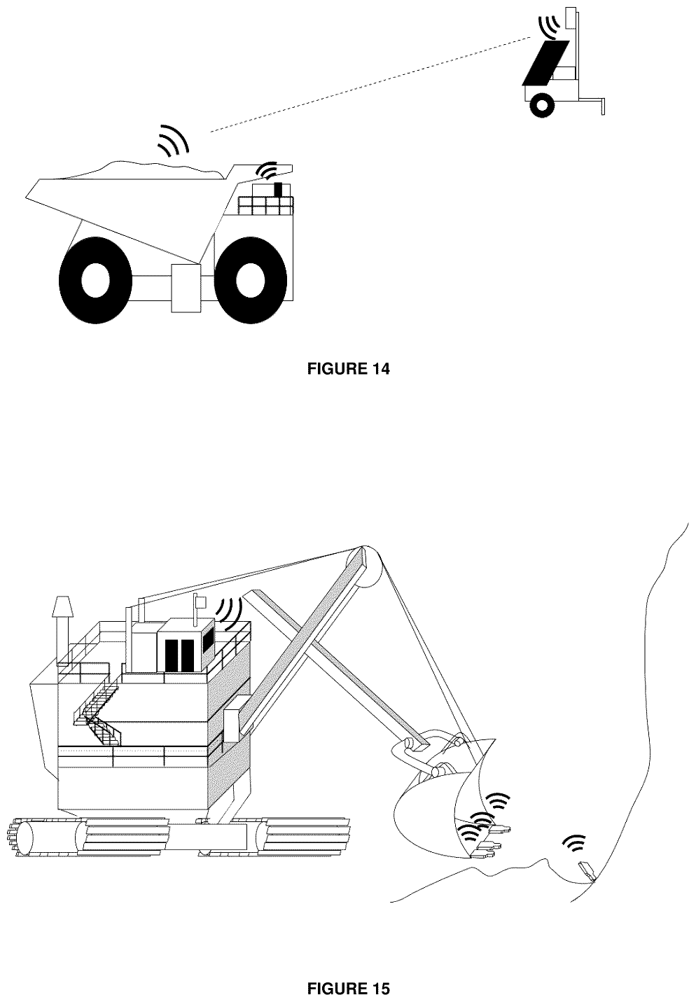

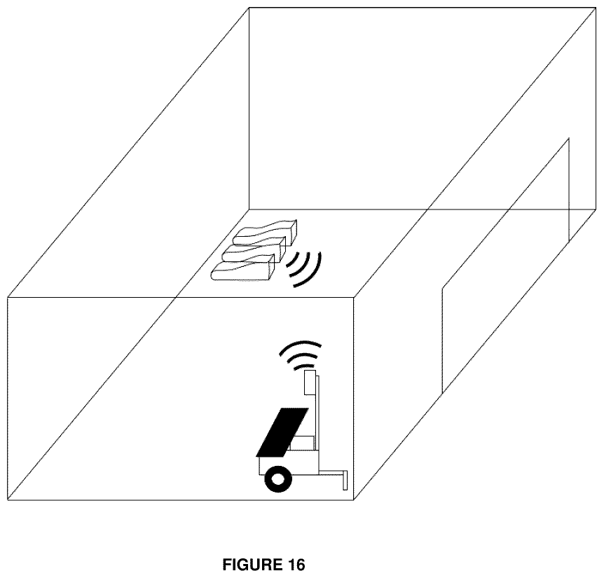

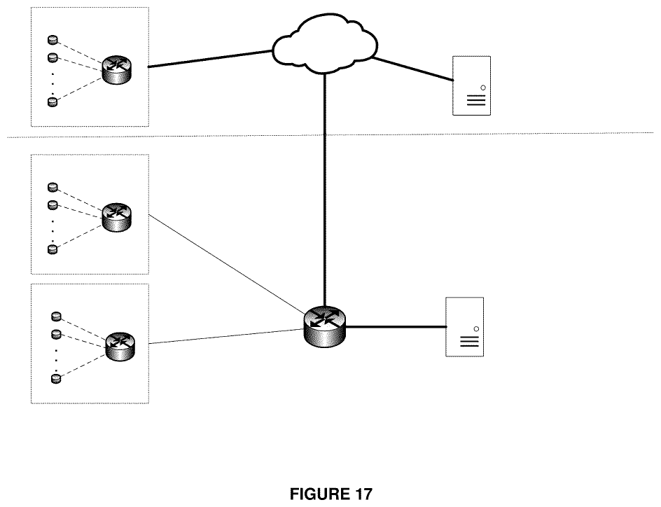

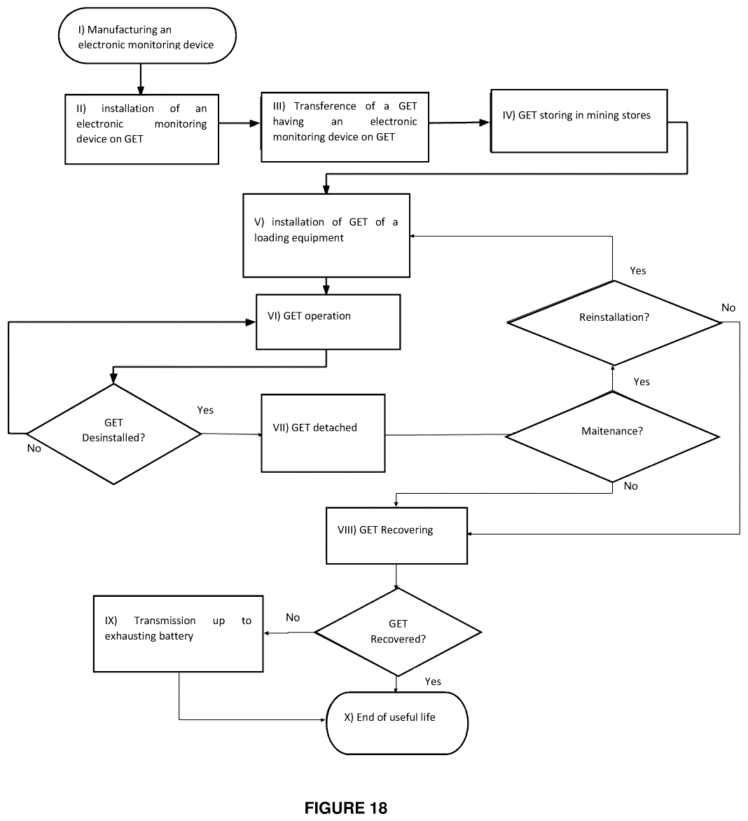

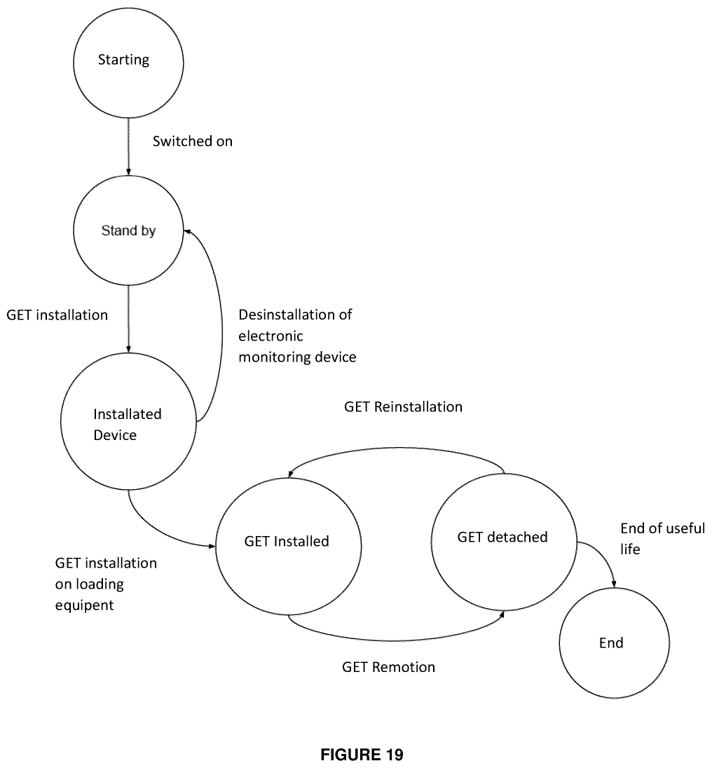

FIGS. 10, 11A, 11B, 12A and 12B show the adjusted or adaptable location of the present electronic monitoring device installed within the housing means (1) outside the cavity (11) of the GET (10), according to the size and shape of said cavity (11). The present electronic monitoring device is located in the GET cavity, so as to level its height with that of the GET cavity when the GET can come into contact with its clamping element, being tooth-adapter, adapter-lip, shroud-lip, sidebar protector-bucket, among other interfaces that are generated from the GET-clamping element combination. Whereas the location of the present monitoring device protrudes from the GET cavity if said GET and its clamping element do not touch.

The location of the present electronic monitoring device is in the cavity between the GET and its clamping elements. The electronic monitoring device is then protected from shocks—by external elements—that may occur either on the side, front, top or bottom areas of the GET, and the location of the GET cavity is one that allows the present electronic monitoring device to be in front of an attachment element of the GET. The fastening elements may be, but not limited to, to adapter relative to tooth, lip relative to adapter, lip relative to in-between, bucket relative to keeper, among others, thereby allowing detection of installation/re-installation and detachment/removal by measurement of the gap between the present electronic monitoring device and the metal part it faces. The cavity (11) has a geometry that facilitates the installation of the present electronic device, being then, preferably cylindrical, of low height.

The protective outer casing (2) of the present electronic monitoring device may furthermore have at least 2 slight lateral cylindrical widenings (6), which may assist in achieving the secure anchoring of the electronic monitoring device to the GET, preventing internal movement of the components located inside the protective outer casing (2). In the first and second embodiment, the fin-type fastening means (4) allow a fastening between the outer protective housing (2) and the outer housing medium (1), of the floating type or enabled only by means of a snap connection between the fins (4) and the slots (5) which receive them, thus making it possible to reduce heat transfer from the outer housing medium (1) to the protective outer casing (2) and to the interior of the latter, since the contact surfaces between the outer housing medium (1) and the protective outer casing (2) are reduced, and air circulates more easily to the interior of the outer housing medium (1). The protective inner housing (2) as well as the outer housing means (1) are made of a polymeric material. Optionally, the inside of the outer housing medium (1) can be filled with a thermal insulating material such as Aerogel or its derivatives or mixtures to increase the insulating capacity.

With respect to said plurality of electronic and programmable components, located inside the protective outer casing (2) of the present self-contained electronic monitoring device that allows tracking and detecting its installation/re-installation and detachment/removal on a GET, as well as the installation/re-installation and detachment/removal of GET with electronic monitoring device with respect to a fastening element on an earthmoving machine, throughout its life cycle, managing power consumption, establishing wireless communication in high metallic environments and detecting according to 4 main operating states, i.e., “Standby”, “Device Installed”, “GET Installed” or “GET Detached”, comprising:
a) control and data processing means comprising at least a first microcontroller programmed or microprocessor to establish one of said 4 lifecycle operating states, wherein said microprocessor receives wireless communication signals and digital data/information from sensing means, processes said wireless communication signals and digital data/information to establish one of said 4 lifecycle operating states, controls the remaining means of the device (means b)-f) described below) according to said life cycle operation state determined for said GET, and sends said wireless communication signals and digital data/information from said determined life cycle state to control means and manages power consumption as described in Table 1 and establishes the wireless communication protocol as described in Table 2;
b) control and power management means comprising a first electronic circuit that activates the power supply according to said determined life cycle operation state as described in Table 1 upon receiving signals from said at least one first microcontroller of said control and data processing means;
c) power supply means comprising at least one battery or power cell, which may optionally also be provided with a second electronic circuit comprising at least one capacitor or supercapacitor that provide additional power when the power demand of one or more of the circuits of any of the means described above, in a) and b), or subsequently, from c) to g), becomes more intense, thus supporting the power supply distributed by said at least one battery or cell;
d) means for converting analog signals into digital signals and digital signals into analog signals comprising a third electronic circuit comprising at least a first converter of analog voltage signal into digital signal, at least a second converter of digital signal into analog voltage signal, at least a fourth electronic circuit of voltage or current amplification, and optionally, at least a fifth electronic circuit comprising preamplifiers, amplifiers and transistors, wherein said analog signals converted into digital signals are sent to said at least a first microprocessor of said sensing means with said digital data/information of the power consumption, which is linked to said data/information of the operating status of the life cycle of the GET;
e) means of wireless microwave/radio frequency communication for highly metallic environment, comprising a sixth electronic circuit and transceivers allowing to send, receive and decode wireless signals mainly in the range of 2400 MHz to 2500 MHz, wherein said sixth electronic circuit allows the activation of one or a combination of at least two of the communication protocols “Bluetooth Low Energy”, “Lora”, “Lora Ranging Engine Packet”, “GFSK”, “FLRC”, and further comprising a means of emission or reception of microwave/radio frequency signals in metallic environment, preferably, a first transmitter or receiver, “Lora Ranging Engine Packet”, “GFSK”, “FLRC”, and further comprising a means for transmitting or receiving microwave/radio frequency signals in metallic environment, preferably, a first resonant antenna, operating without detuning within a cavity (11) in said GET and wherein said cavity (11) in said GET is located in a GET interface-holding element, wherein said GET interface-holding element may be selected from: tooth-adapter, adapter-tooth-lip, adapter-tooth-lip, sidebar protector-bucket, and converts electrical signals into non-ionizing electromagnetic signals establishing a wireless communication with receiving means or communication modules, wherein, preferably, said receiving means are one or more “Gateway”, and further optionally, notify data/information of battery status, temperature inside the electronic monitoring device, among others, wherein said data/information is received from sensing means measuring temperature, battery status, among others; and wherein said wireless communication/notification is performed according to the determined life cycle operation status as described in Table 2 and wherein said power management is performed according to the determined life cycle operation status as described in Table 1,
wherein said means a)-e) further optionally each comprise a plurality of passive and active electronic means selected from at least one resistor, at least one capacitor, at least one inductor, at least one transistor, at least one diode, among other non-programmable components, as required,
wherein said first, second, third, fourth, fourth, fifth and sixth electronic circuits of means a)-e) may be located on one or more electronic boards/boards;
f) sensing means for detecting installation/re-installation and detachment/removal of said electronic monitoring device on a GET, and installation/re-installation and detachment/removal of said GET with electronic monitoring device on an earthmoving machine, by activating sensing means having a first twin of said sensing means located at the bottom and second twin of said sensing means located at the top, wherein said first and second twins of said sensing means are activated according to the operating state of Table 3. Thus, in the “Standby” or “Device Installed” states, said first twin of said sensing means, performs measurements pointing towards the inside of the GET. Whereas said second twin of sensing means performs measurements pointing towards the clamping element, in the states “Device Installed”, “GET Installed” or “GET Detached”. Said sensing means comprise:
f.1) first sensing means for detecting the installation/re-installation and detachment/removal of said electronic monitoring device on a GET, as well as the state of installation/re-installation and detachment/removal of said GET with electronic monitoring device from its fastening element by means of magnetic hysteresis curves or magnetic “minor loops” curves, comprising:
   f.1.1) at least one first emitting coil in a seventh electronic circuit—which may or may not be resonant—which allows to generate/emit/induce an alternating magnetic field in a frequency range between 50 Hz and 50.000 Hz, wherein said at least one first emitting coil is selected from: a winding, preferably of copper, or from a printed circuit board, which may optionally also comprise a ferromagnetic core, in order to concentrate magnetic field lines and thus to intensify said alternating magnetic field in a given region of the GET or clamping element;
   f.1.2) an eighth electronic circuit, for sensing/reading/detecting magnetic fields in said frequency range of said at least one first emitting coil, comprising at least one first reading coil, wherein said at least one first reading coil is selected from a winding, preferably of copper or from a printed circuit board; and
wherein said first microcontroller of said control and data processing means controls the frequency and amplitude of said electrical signal supplied to said seventh electrical circuit of said at least one first emitting coil and processes the same, with a measurement rate according to the operating state of Table 3,
wherein said at least one first electromagnetic signal emitting coil and said at least one first magnetic signal reading coil are located in contact with or in close proximity and directed/pointing to said GET, first twin of said sensing means, or to its holding element, second twin of said sensing means, according to the operating state of Table 3, said location being selected close and directed/pointing to the GET holding element or to its holding element of:
   Lower location as described in Table 3; or
   Top location as described in Table 3;
wherein said at least one first emitting coil generates an external alternating magnetic field or “H-field”, which excites the magnetic moments of said GET or clamping elements, corresponding to ferromagnetic materials,
wherein the emission frequency of said first emitting coil is controlled by said control means in the above mentioned low frequency range to ensure that the alternating magnetic field will not be mostly transformed into eddy currents, and in this way, said alternating magnetic field preferably penetrates towards the inside of said GET or fastening elements corresponding to a ferromagnetic material and interacts with the largest amount of the volume of said GET or fastening elements corresponding to ferromagnetic material, which is in front of it,
wherein said at least one first readout coil senses/measures the magnetic field resulting from the interaction of said external alternating magnetic field, denoted “H-field”, of low frequency, coming from said at least one first emitting coil, and the induced magnetic field, denoted “B-field”, of the ferromagnetic material of said GET or fastening elements; and further, said voltage signals supplied to said at least one first emitting coil, as said voltage signal induced to said at least one first reading coil, are processed by the control and data processing means, as values of “B field” and “H field”, which allow to obtain magnetic hysteresis curves or magnetic “minor loops”, of “B” vs “H”, and from said curves both the installation/re-installation is determined, or detachment/removal of such electronic monitoring device on the GET, such as installation/re-installation, or detachment/removal of such GET with electronic monitoring device from a fixture, in front of such sensing means, as the case may be, respectively, or
f.2) second sensing means for detecting the installation/re-installation and detachment/removal of said electronic monitoring device on a GET, as well as the installation/re-installation and detachment/removal status of said GET with electronic monitoring device with respect to a clamping element, by means of amplitude changes of the standing wave in the transmission line of a second resonant antenna, comprising:
   f.2.1) a first microwave circuit emitting radio frequency signals compatible with the wireless communication frequency of said second resonant antenna at a frequency between 2400 Mhz-2500 MHz;
   f.2.2) at least one radio frequency signal directional coupling means, which makes it possible to divide said radio frequency signal emitted by said first microwave circuit by means of 3 terminals, and without significantly degrading it; and
   f.2.3) at least one power meter means, envelope detector or the like, operating at said communication frequency of said second resonant antenna, which detects the amplitude of said radio frequency signal and digitizes said radio frequency signal to send said digitized signal to said at least one first microprocessor,
wherein said third terminal is connected to said power meter which monitors the intensity of said standing wave through the Standing Wave Ratio (SWR) or geometric ratio between the maximum voltage and the minimum voltage, wherein if the value of SWR is greater than or equal to 3 for said second resonant antenna, which confirms the installation/reinstallation of said electronic monitoring device in the GET, or of the GET with electronic monitoring device with respect to a fastening element, and any value less than 3 for said second resonant antenna, confirms the detachment/removal of said electronic monitoring device in the GET, or of said GET with electronic monitoring device monitoring regarding a fastening element in an earth-moving machine,
wherein said standing wave intensity signals monitored by said power meter are digitized and sent to said at least one first microprocessor, with a measurement rate according to the operating state of Table 3, to detect installation/re-installation or detachment/removal of said electronic monitoring device in a GET, or of said GET with electronic monitoring device with respect to a clamping element through changes in the amplitude of the standing wave in the transmission line, which corresponds to a copper conductive tape with geometric dimensions proportional to the aforementioned frequency range that excites said second resonant antenna; and said change in the near environment of said second resonant antenna caused by the presence of a metal, installation/removal of said electronic monitoring device in a GET, or of said GET with electronic monitoring device with respect to a clamping element, which causes a change in the impedance of the latter, generating a standing wave whose amplitude is proportional to the change introduced in said close environment of said second resonant antenna, modifying its efficiency,
when a communications module communicates wirelessly and directly with said second resonant antenna, it transmits most of the energy it emits, the amplitude of said wireless transmission energy being modified when the nearby environment of said second resonant antenna changes by installation/re-installation or detachment/removal of said electronic monitoring device on said GET, or of said GET with electronic monitoring device with respect to a fastening element, thereby modifying the efficiency of said second resonant antenna,
wherein said first resonant antenna means e) may be equal to or different from said second resonant antenna means f.2),
f.3) third means of sensing the installation/re-installation and detachment/removal of said electronic monitoring device on a GET, as well as the installation/re-installation and detachment/removal status of said GET with electronic monitoring device with respect to a fastener, detecting changes in amplitude and phase of an RLC circuit with respect to a thermally normalized self-resonant RLC circuit occurring in an installation/re-installation or detachment/removal event of said electronic monitoring device in the GET, or of said GET with electronic monitoring device with respect to a clamping element, comprising:
   f.3.1) at least one second emitter coil in a ninth high-frequency self-resonant RLC electronic circuit for generating/emitting/inducing an alternating magnetic field in a frequency range between 50 KHz and 10 MHz, wherein said at least one second emitter coil is selected from: a winding, preferably of copper, or from a printed circuit board;
   f.3.2) at least one temperature sensor which registers its reading in said first microcontroller;
   f.3.3) a tenth RLC electronic circuit comprising a second magnetic field reading coil, wherein said tenth RLC electronic circuit senses/measures magnetic fields in said frequency range of said at least one second emitting coil, wherein said at least one second reading coil is selected from a winding, preferably of copper or else from a printed circuit board; and wherein said first microcontroller of said data processing and control means records the self-resonant frequency of said electrical signal supplied to said ninth electrical circuit of said at least one second transmitting coil, and allows said ninth electrical circuit to be excited at the recorded resonant frequency, and processes the same, and wherein said first microcontroller of said data processing and control means records amplitude and phase of said electrical signal induced in said tenth electrical circuit of said at least one second reading coil and processes the same, with a measurement rate according to the operating state of Table 3;
wherein said at least one second electromagnetic signal emitting coil and said at least one second magnetic signal reading coil, are located in contact with or in close proximity and directed/pointing to said GET or its holding element, said location being selected close and directed/pointing to said GET or its holding element from:
   Lower location as described in Table 3
   Upper location as described in Table 3;
wherein the temperature recording in said first microcontroller, is performed simultaneously with the recording of frequency, amplitude and phase, and thereby, a detection of changes in amplitude and phase in said tenth RLC electronic circuit is performed; also, said first microcontroller of said control and processing means performs a normalization with respect to the temperature of said amplitude and phase variables, with respect to an event of installation/re-installation or detachment/removal of said electronic monitoring device in the GET, or of said GET with electronic monitoring device of a fastening element in an earthmoving machine; or
f.4) fourth means for detecting the installation/re-installation and detachment/removal of said electronic monitoring device on a GET, as well as the installation/re-installation and detachment/removal status of said GET with electronic monitoring device with respect to a clamping element by means of self-frequency analysis, comprising an eleventh high frequency self-resonant RLC electronic circuit enabling to generate/emit/induce an alternating magnetic field in a frequency range between 50 kHz and 10 MHz, wherein said at least a third emitting coil is selected from: a winding, preferably of copper, or else from a printed circuit board;
and wherein said first microcontroller of said control and data processing means records the self-resonant frequency of said electrical signal supplied to said eleventh electrical circuit of said at least one third emitting coil, and processes the same at a measurement rate according to the operating state of Table 3, wherein said coil is located in contact with or in close proximity and directed/pointing to said GET or its clamping element according to the operating state of Table 3, said location being selected close and directed/pointing to said GET or its clamping element from:
   Lower location as described in Table 3
   Upper location as described in Table 3;
      with respect to an installation/re-installation or detachment/removal event of said electronic monitoring device on a GET, or of said GET with electronic monitoring device with respect to a fastening element; or
      g) means for temperature sensing in said electronic monitoring device comprising at least with a temperature sensor recording its reading in said first microcontroller, for alerting to high or low temperatures, which may be outside the operating range of the electronic components comprised in the electronic monitoring device; wherein said high temperatures correspond to temperatures of 85° C. or higher and said low temperatures correspond to temperatures of −40° C. or lower, and wherein said alerting comprises activating visual or audible alarm means.

The present monitoring system allows autonomously tracking, detecting and reporting the installation/re-installation or detachment/removal of an electronic monitoring device on a GET and the installation/re-installation or detachment/removal of a GET with electronic monitoring device with respect to a fastening element on an earthmoving machine, throughout its service life cycle, with management of the energy consumption, establishing wireless communication in highly metallic environments and detecting based on 4 main states of the life cycle of the GET, that is, “Standby”, “Device Installed”, “GET Installed” and “GET Detached”, comprising:
a) at least one electronic monitoring device as described above, corresponding to at least one sensor node that is installed in at least one GET, and is located in a cavity (11) of said GET, in front of its fastening element, where it is not exposed to abrasion from the environment, and monitors said GET autonomously, sending data/information of the lifecycle operation status to a “Gateway” according to the wireless communication protocols described in Table 2, managing the power consumption of the power source as described in Table 1 and detecting installation/re-installation or detachment/removal as described in Table 3;
b) at least one central wireless communication coordination equipment or “Gateway” operating in star-type or mesh-type topology, or both, as a coordination mode for such wireless communication, where such “Gateway” may be located at each location/location associated with one of the 4 operating states aforementioned life cycle of said GET, preferably, and by virtue of monitoring the detachment of said GET, on an earthmoving machine, for example, a shovel of mining loading equipment, wherein said “Gateway” may be located on the cab roof or on the mast/arm of said shovel of mining loading equipment, but by way of example and not limited thereto, as it may be located in an appropriate part on said earthmoving machine that allows to establish said wireless communication sought based on the wireless communication protocols described in Table 1 above, and optionally, complementary protocols selected from one or more protocols, selected from “WIFI” may be added to create local wireless communication networks between the “Gateways” and establish wireless communication with user interfaces, by way of example but not limited to, said user interfaces may be selected from a GET monitor display tablet in operator's cab of said earthmoving machine; or Lora at 915 MHz, 868 MHz or 433 MHz, to communicate with a plurality of “Gateways”, as well as communication modules selected from cellular communication modules either 3G, 4G, 5G or 6G that allow access to the Internet, and with it, a direct connection to the cloud and also to physical servers with Internet access that can in turn connect to the cloud, and optionally also, a radio navigation or positioning system (GPS) that allows establishing the global position of said plurality of “Gateways”, and consequently, of the electronic monitoring devices connected to said plurality of “Gateways”;
c) at least one server corresponding to a computer equipment connected to a local network or the Internet, which stores, organizes and consults data/information from each of the means comprising an electronic monitoring device, and equipment operating in the network, including “Gateways”, “Routers”, cloud, Servers with Internet connection, and optionally
d) means for activating or enabling the generation of visual signals, auditory signals or both, wherein said means for activating or enabling the generation of visual signals, auditory signals or both are selected from visual or auditory signal emitting means selected from sirens, horns, loudspeakers, loudspeaker, computer screens or wireless devices with digital display, with access to a telephone or satellite network and the Internet, among others, wherein said visual signals are selected from text notes, images or both, wherein said visual alarms, audible alarms or both, are generated or sent, autonomously, either to an operator of the earthmoving machine or at a monitoring station with a server connected to the network and which is located at the place of operation of the earthmoving machine or both, by way of example but not limited to, said audible signal, message with a text notification or both are displayed on the screen of a computer, cell phone, tablet, among others, and optionally
e) at least one module or portable equipment for scanning an electronic monitoring device in “GET Detached” state that may have the same attributes of a “Gateway”, that is, wireless communication, Internet connection, connection to the network of electronic monitoring devices, a computing or processing unit capable of receiving, processing and sending data/information from one network to another, with a power supply system that allows it temporary autonomy for a few hours, and whose function is to allow the location of a detached GET in order to recover it,
being said at least one module or portable equipment for scanning, in wireless communication with said detached GET according to the wireless communication protocol described in Table 1, which allows estimating the distance between transmitter (GET)-receiver where said receiver is selected from a portable equipment for scanning, preferably, using the “Lora Ranging Engine Packet” protocol.

In this way, and by way of example without limitation, when the present electronic monitoring device installed in a GET autonomously wirelessly reports/communicates with at least one “Gateway”, it sends data/information of its identification, life cycle operation status, detachment status, temperature, battery level or a combination thereof, by means of radio wave signals emitted by said first resonant antenna operated by said communications module which communicates with one or more communication protocols depending on the life cycle operation and detachment status of the GET, see Table 2, and such data/information is received and processed by said at least one “Gateway”, and optionally and additionally may be collected by a “Central Gateway” that receives said processed data/information from multiple electronic monitoring devices, and transmits said data/information to a display device, e.g., a Tablet, or to a network either internal to the mine or one with Internet access. Likewise, a “Gateway” receiving data/information from an electronic monitoring device may send data/information, instructions, or both to said electronic monitoring device to facilitate coordination and power management, by way of example and not limited to, they may exchange data/information identifying the electronic monitoring device and “Gateway” in communication, which may assist in obtaining a relative position of the GET. The monitoring of such electronic device is mainly done through “Gateway” that can also be installed in warehouses, transport trucks, storage, distribution, and maintenance or repair centers, among others.

Thus, when a GET on an earthmoving machine in operation, it can report to a “Gateway” located on the roof of said earthmoving machine or on the side of its cab, mast, or any other location on the machine facing the GET, and the tracking of the electronic monitoring device will indicate that it is operating on the same machine on which said “Gateway” is mounted, and data/information is additionally and optionally collected relative to said “Gateway” sending, to which display device it sends, and which “Gateway” processes said data/information, the only difference being that relative to detachment detection, where the transmission/sending of data/information is done on another transmission band or channel, with respect to the channel or band used for coordination of the sensor nodes in operation. When a detachment occurs, the following is added, in addition to the emission of an alarm signal, which is constantly sent on a dedicated channel, which is constantly monitored by the gateway. When a gateway receives such alarm signal, it associates the GET with the electronic monitoring device in “GET Detached” state and notifies the detachment through its graphic interface, and additionally and optionally notifies the network to which it is connected, for example, but not limited to, a local network of the mine or the Internet.

When the GET is in the “GET Detached” state, said electronic monitoring device sends information for its recovery and uses in parallel a combination of at least two of said 4 wireless communication protocols indicated as “active” in Table 2, where one of them corresponds to the “Lora Ranging Engine Packet”, to determine the distance between said detached GET and an autonomous or remote-controlled robotic operator or equipment, equipped with a module to scan said wireless signal, which travels through the estimated place where the GET could have fallen, seeking to minimize the distance between the scanning module and the detached GET, and when such distance cannot be reduced any further, dig in case it is not in a visible location, and thus, recover the GET, where such scanning module has the same communication capabilities as a “Gateway” but unlike the latter, it accesses the local network or Internet, wirelessly, and has batteries for sporadic use, of a few hours; while the other protocol sends, in parallel, information on its identification, temperature, battery level, life cycle status and detachment status.

Autonomous monitoring method allowing to detect the installation/re-installation and detachment/removal of an electronic monitoring device in a GET, and the installation/re-installation and detachment/removal of a GET with electronic monitoring device with respect to a clamping element of an earthmoving machine, by activating sensing means having a first sensing means twin and a second sensing means twin which are activated according to the operating state as described in Table 3. Thus, to autonomously detect the installation/re-installation and detachment/removal of an electronic monitoring device in a GET, in the states “Standby” or “Device Installed”, being said first twin of said sensing means, located at the bottom of an electronic monitoring device as described above, who performs the measurements, pointing towards the interior of the GET. Whereas for autonomously detecting the installation/re-installation and detachment/removal of said GET with electronic monitoring device from its fastening element, it is said second twin of said sensing means, located on top of said electronic monitoring device, that performs measurements, pointing towards a fastening element, in the states “Device Installed”, “GET Installed” and “GET Detached”; wherein installation/re-installation and detachment/removal are determined by a combination of at least one or more of the following options based on measurements of said sensing means:
a.1) obtaining magnetic hysteresis curves or magnetic “minor loops” curves from the generation of an external alternating magnetic field, called “H field”, in a low frequency range between 50 Hz and 50,000 Hz, inside said electronic monitoring device, which can optionally be intensified with magnetic field lines concentrated in a determined region of said GET or a clamping element, both materials with ferromagnetic characteristics; and controlling frequency and amplitude;
where the magnetic field resulting from the interaction of said external alternating magnetic field, called “H-field”, of low frequency, and the magnetic field induced by said GET or a clamping element, called “B-field”, is sensed/measured; in addition, the voltage signals supplied both to generate the alternating field and to read it, values of “H field” and “B field”, respectively, are recorded, from which are obtained said magnetic hysteresis curves or magnetic “minor loops”, of B vs H, from which is determined the installation/re-installation or detachment/removal of an electronic monitoring device inside a GET, using said first twin of said sensing means, or the installation/re-installation or detachment/removal of a GET with electronic monitoring device with respect to a clamping element using said second twin of said sensing means, and
the relative magnetic permeability of the GET is estimated, using said first twin of said sensing means, or of said fastening element, using said second twin of said sensing means, which said sensing means face, where said relative magnetic permeability corresponds to the slope of said curve “B” vs “H” divided by magnetic permeability of the vacuum, and if the value of the slope is much greater than 1, said electronic monitoring device or said GET with electronic monitoring device with respect to a clamping element, is considered to be installed/re-installed, because said sensing means are in the presence of, either of the GET or its fastening element, respectively, which always present relative magnetic permeability values much higher than 1, because they are ferromagnetic materials, whereas if the slope value is close or equal to 1, said electronic monitoring device or said GET with electronic monitoring device with respect to a fastening element, is considered as detached/uninstalled, because it is confirmed that said sensing means are in the presence of non-ferromagnetic materials, for example, air, which presents relative magnetic permeability close or equal to 1, or
a.2) obtaining magnetic hysteresis curves or magnetic “minor loops” curves from the generation of an external alternating magnetic field, called “H field”, in a low frequency range between 50 Hz and 50,000 Hz inside the electronic monitoring device, which can also optionally be intensified with magnetic field lines concentrated in a certain region of the GET or the clamping element, having both materials, ferromagnetic characteristics; and controlling frequency and amplitude;
where the magnetic field resulting from the interaction of said external alternating magnetic field, denominated “H field”, of low frequency, and the magnetic field induced by said GET or a clamping element, denominated “B field”, is sensed/measured; in addition, the voltage signals supplied both to generate the alternating field and to read it, values of “H field” and “B field”, respectively, are recorded, with which said magnetic hysteresis curves or magnetic “minor loops” of “B” vs “H” are obtained, from which is determined the installation/re-installation or detachment/removal of an electronic monitoring device inside a GET, using said first twin of said sensing means, or the installation/re-installation or detachment/removal of a GET with electronic monitoring device of a clamping element, using said second twin of said sensing means, and
the magnetic coercivity of the hysteresis curve and “minor loop” of “B” vs “H” of the GET, ferromagnetic material, is estimated, using said first twin means of said sensing means, or of the clamping element, using said second twin of said sensing means, which said sensing means face, by determining the pair of positive and negative values of the hysteresis curve of the “H field”, and is calculated when the difference between said pair of values sets the crossing or value B=0; if the absolute value of “H” is different and much higher than zero, said electronic monitoring device or a GET with electronic monitoring device with respect to a clamping element, is installed/re-installed since said sensing means are in the presence of said GET or clamping element, respectively, which always present magnetic coercivity values much higher than zero, since both materials are ferromagnetic, whereas, if the absolute value of “H” is very close to zero, said electronic monitoring device or GET with electronic monitoring device with respect to a clamping element is detached/uninstalled since said sensing means are in the presence of a non-ferromagnetic material, e.g., air, which presents magnetic coercivity close to or equal to zero; or
a.3) obtaining magnetic hysteresis curves or magnetic “minor loops” curves from the generation of an external alternating magnetic field, denominated “H field”, in a low frequency range between 50 Hz and 50,000 Hz inside said electronic monitoring device, which optionally can also be intensified with magnetic field lines concentrated in a determined region of the GET or clamping element, both materials with ferromagnetic characteristics; and controlling frequency and amplitude;
where the magnetic field resulting from the interaction of said external alternating magnetic field, called “H-field”, of low frequency, and the magnetic field induced by said GET or a clamping element, called “B-field”, is sensed/measured; in addition, the voltage signals supplied both to generate the alternating field and to read it, values of “H field” and “B field”, respectively, are recorded, with which said magnetic hysteresis curves or magnetic “minor loops” of “B” vs “H” are obtained, from which the installation/installation is determined, or detachment/removal of an electronic monitoring device inside a GET, using said first twin of said sensing means, or the installation/re-installation or detachment/removal of a GET with electronic monitoring device with respect to a fastening element, using said second twin of said sensing means, and
the magnetic remanence field in curves “B” vs “H”, of the GET, using said first twin of said sensing means, or of the clamping element, using said second twin of said sensing means, which said sensing means face, is determined by determining the pair of positive and negative values of the hysteresis curve of the “B field” when the value of H=0; if the absolute value of “B” is always much higher than zero, said electronic monitoring device or said GET with electronic monitoring device with respect to a clamping element, is installed/re-installed since said sensing means are in the presence of the GET or the clamping element, respectively, which always present magnetic remanence values much higher than zero, since both materials are ferromagnetic, whereas, if the absolute value of “B” is very close to zero, said electronic monitoring device or GET with electronic monitoring device with respect to a clamping element has been detached/uninstalled since the sensing means are in the presence of a non-ferromagnetic material, e.g., air, which presents magnetic remanence close to or equal to zero; or
a.4) generation of a radio frequency standing wave whose amplitude changes in the presence of said GET or clamping element, which correspond to a metal, and are in front of either said first twin of said sensing means or said second twin of said sensing means, respectively, causing a change in the impedance of a second resonant antenna, and which change in amplitude is proportional to the change in said environment of metal masses near said second resonant antenna, which changes its efficiency, wherein a radio frequency signal compatible with the wireless communication frequency of said second resonant antenna between 2400 Mhz-2500 MHz is emitted and the amplitude thereof is detected, and wherein a communications module communicates wirelessly and directly with said second resonant antenna, it transmits most of the energy it emits, the amplitude of said wireless transmission energy being modified, when the nearby environment of said second resonant antenna is changed by the presence or installation/re-installation, or absence or detachment/removal of an electronic monitoring device, or GET with electronic monitoring device with respect to a clamping element, thereby modifying the efficiency of said second resonant antenna, and then, monitoring the intensity of said standing wave through the Standing Wave Ratio (SWR) or geometric ratio between the maximum voltage and the minimum voltage, wherein the SWR value is greater than or equal to 3 for said second resonant antenna, which confirms the installation/re-installation of said electronic monitoring device, or said GET with electronic monitoring device with respect to a clamping element, and any value less than 3 for said second resonant antenna, confirms the detachment/removal of said electronic monitoring device, or said GET with electronic monitoring device with respect to a clamping element; or
a5) by detecting the changes in amplitude and phase of an RLC circuit, with respect to a self-resonant, high-frequency RLC circuit, in the frequency range between 50 KHz and 10 MHz, with thermal normalization, where the resonance frequency of the self-resonant RLC circuit for when said electronic monitoring device or GET with electronic monitoring device changes its metallic environment due to an installation/re-installation or detachment/removal event of an electronic monitoring device in a GET, said first twin being used of said sensing means, or the installation/re-installation or detachment/removal of a GET with an electronic monitoring device with respect to a fastening element, said second twin of said sensing means being used, the initial frequency of the self-resonant RLC circuit being recorded, and the initial values of amplitude and phase in the RLC circuit, at a certain temperature, prior to the installation events, both of said electronic monitoring device in a GET, and said GET with electronic monitoring device in its respective control element. clamping, and where said resonance frequency obtained is used to induce an alternating magnetic field, and where said resonance frequency obtained is used to induce an alternating magnetic field, and the voltage signal induced in the RLC circuit is measured, which contains amplitude and phase information, simultaneously measuring also the temperature inside said electronic monitoring device, which in turn is used to perform a thermal normalization of said amplitude and phase values; and, if said amplitude and phase values change with respect to initial values recorded prior to the event, it is determined that an installation/re-installation event of said electronic monitoring device in the GET, or of said GET with electronic monitoring device with respect to a clamping element has occurred; and, if being installed said electronic monitoring device or said GET with electronic monitoring device with respect to a clamping element, said amplitude and phase values are equivalent to the values recorded initially, it is determined that a detachment/removal event has occurred of said electronic monitoring device on the GET or of said GET with electronic monitoring device with respect to a clamping element; said amplitude and phase values may vary according to the method of GET manufacture, by forging or casting, its chemical composition, and the distance at which the sensing means are facing the GET or clamping elements, so calibration curves are previously constructed for said amplitude and phase values; or
a.6) detection of frequency changes of a high frequency self-resonant RLC circuit in the frequency range between 50 KHz and 10 MHz, wherein the resonant frequency of the self-resonant RLC circuit is determined for when said electronic monitoring device or GET with electronic monitoring device, changes its metallic environment due to an event of installation/re-installation or detachment/removal of an electronic monitoring device in a GET, said first twin of said sensing means being used, or the installation/re-installation or detachment/removal of a GET with electronic monitoring device with respect to a clamping element, said second twin of said sensing means being used, the initial resonant frequency of the self-resonant RLC circuit being recorded prior to installation events of both said electronic monitoring device in a GET and said GET with electronic monitoring device with respect to a clamping element, and wherein said recorded initial resonant frequency is used to detect changes in the surrounding metallic environments; and, if said resonance frequency value increases by at least 3% with respect to the initial value recorded prior to the event, it is determined that an installation/re-installation event of said electronic monitoring device on said GET has occurred, or of said GET with electronic monitoring device with respect to a fastener; and, if, with said electronic monitoring device or said GET with electronic monitoring device installed with respect to a fastener, said resonant frequency value is equivalent to the initially recorded value, it is determined that a detachment/removal event of said electronic monitoring device has occurred in the GET or of said GET with electronic monitoring device with respect to a fastener; said resonance frequency values may vary according to the method of manufacture of GET, by forging or casting, its chemical composition, and the distance at which said sensing means are facing said GET or clamping elements, for which reason calibration curves are previously constructed for said resonance frequency value.

Autonomous monitoring method that allows tracking and reporting the installation/re-installation or detachment/removal of an electronic monitoring device inside a GET and the installation/re-installation or detachment/removal of a GET with electronic monitoring device on a clamping element of an earthmoving machine, throughout its life cycle, managing power consumption, establishing wireless communication in highly metallic environments, and detecting based on 4 main selected operating states of “Standby”, “Device Installed”, “GET Installed” and “GET Detached”, comprising the following steps:
a) autonomously establish the “Standby” state in said electronic monitoring device, and for this purpose, a first twin of a sensing medium located at the bottom of said electronic monitoring device performs measurements at a measurement rate of at least once every 60 minutes, according to Table 3, i.e., for every instant before said electronic monitoring device is installed in a GET, furthermore, data/information is transmitted to a network server, every 1 hour to 24 hours, according to Table 1, after the presence of a power source medium selected from a battery or battery pack, in proper working order, is confirmed, wherein said data/information may include the unique identification data of said electronic device, and wherein said network server is in communication with at least one “Gateway” to which said electronic monitoring device autonomously reports, wherein said at least one “Gateway” may be located in the electronic monitoring device storage warehouse, among other possible fixed locations or on the transporting conveyance, wherein said unique identification information or data allows tracking of said electronic monitoring device which may maintain wireless communication with said at least one “Gateway”, or with multiple different “Gateways” along its transport route, this, without varying said reported “Standby” state, wherein said server has data/information about the location of each “Gateway”, this, without varying said “Standby” state, or with multiple different “Gateways” that are in its transfer route, this, without varying said reported “Standby” state, where said server has data/information about the location of each “Gateway”, which allows it to establish a follow-up according to the communication range radius of each “Gateway” installed in the place or places, which can even be of several kilometers, this according to the protocol previously described in Table 2; or
b) autonomously establish “Device Installed” status in said electronic monitoring device, and for this purpose, said first twin of said sensing means located at the bottom of said electronic monitoring device or a second twin of said sensing means located at the top of said electronic monitoring device performs measurements at a measurement rate of at least once every 30 minutes, according to Table 3, furthermore data/information is transmitted to said network server, every 30 minutes to 1 hour, according to Table 1, and optionally, by means of an analog front-end, e.g., a Tablet equipped with said analog front-end, the unique identification number (ID) of the electronic monitoring device associating it with the GET ID is entered into a log, wherein said log may be manually or digitally incorporated by means of a photograph having the GET ID or a scan code, among others, and which may be reported either to said network server via wireless WIFI communication, or to the nearest “Gateway”, allowing the tracking of said GET in an autonomous manner, said data/information being able to be visualized by a user in, by way of example and not limited to, a display device, where said “Gateway” may be located, by way of example and not limited to, in the mine hold or in a GET transfer vehicle, or with a plurality of “Gateways” that are in its transfer route, among others, without varying said “Device Installed” status reported, due to the information or unique identification data of said electronic monitoring device and according to the communication protocol described in Table 2, where said tracking has the wireless communication range radius of each “Gateway”, being even several kilometers, and where in addition each “Gateway” can verify the correct operation of the GET with electronic monitoring device installed; or
c) autonomously establish “GET Installed” status on said electronic monitoring device, and for this purpose, said second twin of said sensing means located on top of said electronic monitoring device performs measurements at a measurement rate of at least once every 10 seconds, according to Table 3, further data/information is transmitted to said network server, every 0.1 second to 3 minutes, according to Table 1, and then, the status of said device is updated on said server, which is connected to a local network, the Internet or the cloud, wherein said change of status may be visualized through a user interface, by way of example and not limited to, a Tablet or any other equipment intended for visualization which may, by way of example and not limited to, be installed in the operator's cab of said earthmoving machine, which is connected to the “Gateway” via a local WIFI network, and optionally, said unique identification between electronic monitoring device and GET allows tracking of the GET while operational in the mine, wherein the wireless communication protocol is conducted as described in Table 2; or
d) autonomously establish “GET Detached” status on said electronic monitoring device, and to this end, said second twin of said sensing means located on top of said electronic monitoring device performs measurements at a measurement rate of at least once every 10 seconds, according to Table 3, further data/information is transmitted to said network server, every 0.1 second to 3 minutes, according to Table 1, wherein the change in status is updated on said server connected to a local network, the Internet or the cloud, and may further optionally be displayed audibly and visually on a user interface, by way of example but not limited to, a Tablet which may be installed in the operator's cab of said earthmoving machine operator, which is connected to the “Gateway” via a local WIFI network, wherein to alert the detachment/removal, autonomously, audible and visual alarms are triggered on other user interfaces intended to monitor the states of said electronic monitoring device, and which are connected to said server dedicated to said earthmoving machine, and wherein optionally, said unique identification between electronic monitoring device and GET allows determining the GET which has detached/detached from said earthmoving machine, wherein the wireless communication protocol is conducted as described in Table 2,
   and optionally comprises retrieving said detached GET by uniquely identifying said GET with installed electronic monitoring device which continues to wirelessly communicate with said “Gateway”, and wherein said network server continues to track the GET by said unique identification, and supported by tracking equipment with scanner to track the detached GET, wherein the wireless communication protocol is conducted as described in Table 2 and further transmitting data/information to said network server, every 0.1 second to 3 minutes, according to Table 1, and thereby retrieving it, and optionally, further comprising:
   re-install the recovered GET, wherein said electronic monitoring device detects that the GET has been re-installed, and autonomously changes its status from “GET Detached” to “GET Installed”, with all alarms associated with said detachment being disabled, and optionally updating said change of status on the user interface, by way of example but not limited to, a Tablet, installed in the operator's cab of said earthmoving machine operator, or other user interfaces that are connected to said server, which is connected to a local network, the Internet or the cloud, and wherein the wireless communication protocol is conducted as described in Table 2 and further data/information is transmitted to said network server, every 0.1 second to 3 minutes, according to Table 1.

Autonomous monitoring method that allows to track, detect and report the installation/re-installation or detachment/removal of an electronic monitoring device in a GET and the installation/re-installation or detachment/removal of a GET with electronic monitoring device with respect to a fastening element in an earthmoving machine, throughout its useful life cycle, by activating sensing means having a first sensing means twin and a second sensing means twin that are activated according to the operating state as described in Table 3. Thus, to autonomously detect the installation/re-installation and detachment/removal of an electronic monitoring device in a GET, in the states “Standby” or “Device Installed”, being said first twin of said sensing means, located at the bottom of said electronic monitoring device, who performs the measurements, pointing towards the interior of the GET. Whereas for autonomously detecting the installation/re-installation and detachment/removal of said GET with electronic monitoring device from its fastening element, it is said second twin of said sensing means, located on the upper part of said electronic monitoring device, who performs the measurements, pointing towards a fastening element, in the states “Device Installed”, “GET Installed” y “GET Detached”; managing power consumption, establishing wireless communication in highly metallic environments, and sensing based on 4 main selected operation states of “Standby”, “Device Installed”, “GET Installed” and “GET Detached”, comprising the following steps:
a) autonomously establish the “Standby” state in said electronic monitoring device, and for this purpose, a first twin of a sensing means located at the bottom of said electronic monitoring device performs measurements at a measurement rate of at least once every 60 minutes, according to Table 3, i.e., for every instant before said electronic monitoring device is installed in a GET, furthermore data/information is transmitted to a network server, every 1 hour to 24, according to Table 1, after the presence of a power source medium selected from a battery or battery pack, in proper working order, is confirmed, wherein said data/information may include the unique identification data of said electronic device, and wherein said network server is in communication with at least one “Gateway” to which said electronic monitoring device reports autonomously, said at least one “Gateway” being located in the electronic monitoring device storage warehouse, among other possible fixed locations or on the means of transport that transports it, wherein said unique identifying information or data allows for tracking said electronic monitoring device which can maintain wireless communication with said at least one gateway, or with multiple different gateways along its travel path, without changing said reported standby status, where said server has data/information about the location of each “Gateway”, which allows it to establish a follow-up according to the communication range radius of each “Gateway” installed in the place or places, which may even be of several kilometers, this according to the protocol described above in Table 2; or
b) autonomously establish “Device Installed” status on said electronic monitoring device, and for this purpose, said first twin of said sensing means located at the bottom of said electronic monitoring device or a second twin of said sensing means located at the top of said electronic monitoring device performs measurements at a measurement rate of at least once every 30 minutes, according to Table 3, furthermore data/information is transmitted to said network server, every 30 minutes to 1 hour, according to Table 1, and optionally, by means of an analog front-end, e.g., a tablet equipped with said analog front-end, the unique identification number (ID) of the electronic monitoring device that associates it with the GET ID is entered into a log, where said log may be manually or digitally incorporated by means of a photograph having the GET ID or a scan code, among others, and which may be reported either to said network server via wireless WIFI communication, or to the nearest “Gateway”, allowing the monitoring of said GET autonomously, said data/information being able to be visualized by a user in, by way of example and without limitation, a display device, where said “Gateway” may be located, by way of example and without limitation, in the mine hold or in a GET transfer vehicle, or with a plurality of “Gateways” that are in its transfer route, among others, without varying said reported “Installed Device” status, due to the information or unique identification data of said electronic monitoring device and according to the communication protocol described in Table 2, where said tracking has the wireless communication range radius of each “Gateway”, being even several kilometers, and where in addition each “Gateway” can verify the correct operation of the GET with electronic monitoring device installed; or
c) autonomously establishing the status “GET Installed” on said electronic monitoring device, and for this purpose, said second twin of said sensing means located on top of said electronic monitoring device performs measurements at a measurement rate of at least once every 10 seconds, according to Table 3, furthermore data/information is transmitted to said network server, every 0.1 second to 3 minutes, according to Table 1, and then, the status of said device is updated on said server, which is connected to a local network, to the Internet or to the cloud, said change of status being able to be visualized through a user interface, by way of example and not limited to, a Tablet or any other equipment intended for visualization which may, by way of example and not limited to, be installed in the operator's cab of said earthmoving machine, which is connected to the “Gateway” via a local WIFI network, and optionally, said unique identification between electronic monitoring device and GET allows tracking of the GET while operational in the mine, wherein the wireless communication protocol is conducted as described in Table 2; or
d) autonomously establishing the “GET Detached” status on said electronic monitoring device, and for this purpose, said second twin of said sensing means located on top of said electronic monitoring device performs measurements at a measurement rate of at least once every 10 seconds, according to Table 3, further data/information is transmitted to said network server, every 0.1 second to 3 minutes, according to Table 1, wherein the change of status is updated on said server connected to a local network, the Internet or the cloud, being further optionally displayed audibly and visually on a user interface, by way of example but not limited to, a Tablet which may be installed in the operator's cab of said earthmoving machine operator, which is connected to the “Gateway” via a local WIFI network, and wherein to alert the detachment/removal, autonomously, audible and visual alarms are activated on other user interfaces intended to monitor the states of said electronic monitoring device, and which are connected to said server dedicated to said earthmoving machine, and wherein optionally said unique identification between electronic monitoring device and GET allows determining the GET that has been detached/uninstalled from said earthmoving machine, wherein the wireless communication protocol is conducted as described in Table 2,
   and optionally comprising retrieving said detached GET by uniquely identifying said GET with installed electronic monitoring device that continues to communicate wirelessly with said “Gateway”, and wherein said network server continues to track the GET by said unique identification, and supported by tracking equipment with scanner to track the detached GET, wherein the wireless communication protocol is conducted as described in Table 2 and further transmitting data/information to said network server, every 0.1 second to 3 minutes, according to Table 1, and thereby retrieving it, and optionally, further comprising:
   re-install the recovered GET, wherein said electronic monitoring device detects that the GET has been re-installed, and autonomously changes its status from “GET Detached” to “GET Installed”, with all alarms associated with said detachment being disabled, and optionally updating said change of status on the user interface, by way of example but not limited to, a Tablet, installed in the operator's cab of said earthmoving machine operator, or other user interfaces that are connected to said server, which is connected to a local network, the Internet or the cloud, and wherein the wireless communication protocol is conducted as described in Table 2 and further data/information is transmitted to said network server, every 0.1 second to 3 minutes, according to Table 1;
   wherein the installation/re-installation and detachment/removal are determined by a combination of at least one or more of the following options based on measurements of said sensing means:
e.1) obtaining magnetic hysteresis curves or magnetic “minor loops” curves from the generation of an external alternating magnetic field, called “H field”, in a low frequency range between 50 Hz and 50,000 Hz, inside said electronic monitoring device, which can optionally be intensified with magnetic field lines concentrated in a determined region of said GET or a clamping element, both materials with ferromagnetic characteristics; and controlling frequency and amplitude;
where the magnetic field resulting from the interaction of said external alternating magnetic field, called “H-field”, of low frequency, and the magnetic field induced by said GET or a clamping element, called “B-field”, is sensed/measured; in addition, the voltage signals supplied both to generate the alternating field and to read it, values of “H field” and “B field”, respectively, are recorded, from which are obtained said magnetic hysteresis curves or magnetic “minor loops”, of B vs H, from which is determined the installation/re-installation or detachment/removal of an electronic monitoring device inside a GET, using said first twin of said sensing means, or the installation/re-installation or detachment/removal of a GET with electronic monitoring device with respect to a clamping element using said second twin of said sensing means, and
the relative magnetic permeability of the GET is estimated, using said first twin of said sensing means, or of said fastening element, using said second twin of said sensing means, which said sensing means face, where said relative magnetic permeability corresponds to the slope of said curve “B” vs “H” divided by magnetic permeability of the vacuum, and if the value of the slope is much greater than 1, said electronic monitoring device or said GET with electronic monitoring device with respect to a clamping element, is considered to be installed/re-installed, because said sensing means are in the presence of, either of the GET or its fastening element, respectively, which always present relative magnetic permeability values much higher than 1, because they are ferromagnetic materials, whereas if the slope value is close or equal to 1, said electronic monitoring device or said GET with electronic monitoring device with respect to a fastening element, is considered as detached/uninstalled, because it is confirmed that said sensing means are in the presence of non-ferromagnetic materials, for example, air, which presents relative magnetic permeability close or equal to 1, or
e.2) obtaining magnetic hysteresis curves or magnetic “minor loops” curves from the generation of an external alternating magnetic field, called “H field”, in a low frequency range between 50 Hz and 50,000 Hz inside the electronic monitoring device, which can also optionally be intensified with magnetic field lines concentrated in a certain region of the GET or the clamping element, having both materials, ferromagnetic characteristics; and controlling frequency and amplitude;
where the magnetic field resulting from the interaction of said external alternating magnetic field, denominated “H field”, of low frequency, and the magnetic field induced by said GET or a clamping element, denominated “B field”, is sensed/measured; in addition, the voltage signals supplied both to generate the alternating field and to read it, values of “H field” and “B field”, respectively, are recorded, with which said magnetic hysteresis curves or magnetic “minor loops” of “B” vs “H” are obtained, from which is determined the installation/re-installation or detachment/removal of an electronic monitoring device inside a GET, using said first twin of said sensing means, or the installation/re-installation or detachment/removal of a GET with electronic monitoring device of a clamping element, using said second twin of said sensing means, and
the magnetic coercivity of the hysteresis curve and “minor loop” of “B” vs “H” of the GET, ferromagnetic material, is estimated, using said first twin means of said sensing means, or of the clamping element, using said second twin of said sensing means, which said sensing means face, by determining the pair of positive and negative values of the hysteresis curve of the “H-field”, and is calculated when the difference between said pair of values establishes the crossover or B-value=0; if the absolute value of “H” is different and much higher than zero, said electronic monitoring device or a GET with electronic monitoring device with respect to a clamping element, is installed/re-installed since said sensing means are in the presence of said GET or clamping element, respectively, which always present magnetic coercivity values much higher than zero, since both materials are ferromagnetic, whereas, if the absolute value of “H” is very close to zero, said electronic monitoring device or GET with electronic monitoring device with respect to a clamping element has been detached/uninstalled since said sensing means are in the presence of a non-ferromagnetic material, e.g., air, which presents magnetic coercivity close to or equal to zero; or
e.3) obtaining magnetic hysteresis curves or magnetic “minor loops” curves from the generation of an external alternating magnetic field, denominated “H field”, in a low frequency range between 50 Hz and 50,000 Hz inside said electronic monitoring device, which optionally can also be intensified with magnetic field lines concentrated in a determined region of the GET or clamping element, both materials with ferromagnetic characteristics; and controlling frequency and amplitude;
where the magnetic field resulting from the interaction of said external alternating magnetic field, denominated “H field”, of low frequency, and the magnetic field induced by said GET or a clamping element, denominated “B field”, is sensed/measured; furthermore, the voltage signals supplied both to generate the alternating field and to read it, values of “H field” and “B field”, respectively, are recorded, with which said magnetic hysteresis curves or magnetic “minor loops” of “B” vs “H” are obtained, from which is determined the installation/re-installation or detachment/removal of an electronic monitoring device inside a GET, using said first twin of said sensing means, or the installation/re-installation or detachment/removal of a GET with electronic monitoring device with respect to a clamping element, using said second twin of said sensing means, and
the magnetic remanence field in curves “B” vs “H”, of the GET is determined, using said first twin of said sensing means, or of said clamping element, using said second twin of said sensing means, which said sensing means face, by determining the pair of positive and negative values of the hysteresis curve of the “B field” when the value of H=0; if the absolute value of “B” is always much higher than zero, said electronic monitoring device or said GET with electronic monitoring device with respect to a clamping element, is installed/re-installed since said sensing means are in the presence of the GET or the clamping element, respectively, which always present magnetic remanence values much higher than zero, since both materials are ferromagnetic, whereas, if the absolute value of “B” is very close to zero, said electronic monitoring device or GET with electronic monitoring device with respect to a clamping element has been detached/uninstalled since the sensing means are in the presence of a non-ferromagnetic material, e.g., air, which presents magnetic remanence close to or equal to zero; or
e.4) generation of a radio frequency standing wave whose amplitude changes in the presence of said GET or clamping element, which correspond to a metal, and are in front of either said first twin of said sensing means or said second twin of said sensing means, respectively, causing a change in the impedance of a second resonant antenna, and which change in amplitude is proportional to the change in said environment of metal masses near said second resonant antenna, which changes its efficiency, wherein a radio frequency signal compatible with the wireless communication frequency of said second resonant antenna between 2400 Mhz-2500 MHz is emitted and the amplitude thereof is detected, and wherein a communications module communicates wirelessly and directly with said second resonant antenna, it transmits most of the energy it emits, the amplitude of said wireless transmission energy being modified, when the nearby environment of said second resonant antenna is changed by the presence or installation/re-installation, or absence or detachment/removable-installation of an electronic monitoring device, or GET with electronic monitoring device with respect to a clamping element, thereby modifying the efficiency of said second resonant antenna, and then, monitoring the intensity of said standing wave through the Standing Wave Ratio (SWR) or geometric ratio between the maximum voltage and the minimum voltage, wherein the SWR value is greater than or equal to 3 for said second resonant antenna, which confirms the installation/re-installation of said electronic monitoring device, or said GET with electronic monitoring device with respect to a clamping element, and any value less than 3 for said second resonant antenna, confirms the detachment/removal of said electronic monitoring device, or said GET with electronic monitoring device with respect to a clamping element; or
e.5) by sensing changes in amplitude and phase of an RLC circuit, with respect to a high frequency self-resonant RLC circuit, in the frequency range between 50 KHz and 10 MHz, with thermal normalization, wherein the resonant frequency of the self-resonant RLC circuit is determined for when said electronic monitoring device or GET with electronic monitoring device, changes its metallic environment due to an event of installation/re-installation or detachment/removal of an electronic monitoring device on a GET, using said first twin of said sensing means, or installation/re-installation or detachment/removal of a GET with electronic monitoring device with respect to a clamping element, using said second twin of said sensing means, the initial frequency of the self-resonant RLC circuit being recorded, and the initial values of amplitude and phase in the RLC circuit, at a certain temperature, prior to the installation events, both of said electronic monitoring device in a GET, and said GET with electronic monitoring device in its respective clamping element, and where said resonance frequency obtained is used to induce an alternating magnetic field, and the voltage signal induced in the RLC circuit is measured, which contains amplitude and phase information, simultaneously measuring also the temperature inside said electronic monitoring device, which in turn is used to perform a thermal normalization of said amplitude and phase values; and, if said amplitude and phase values change with respect to initial values recorded prior to the event, it is determined that an installation/re-installation event of said electronic monitoring device in the GET, or of said GET with electronic monitoring device with respect to a clamping element, has occurred; and, if, when said electronic monitoring device or said GET with electronic monitoring device is installed with respect to a fastener, said amplitude and phase values are equivalent to the initially recorded values, it is determined that a detachment/removal event of said electronic monitoring device has occurred in the GET or said GET with electronic monitoring device with respect to a fastener; said amplitude and phase values may vary depending on the method of manufacture of GET, by forging or casting, its chemical composition, and the distance at which the sensing means are facing the GET or clamping elements, so calibration curves are previously constructed for said amplitude and phase values; or
e.6) detection of the frequency changes of a high frequency self-resonant RLC circuit in the frequency range between 50 KHz and 10 MHz, wherein the resonant frequency of the self-resonant RLC circuit is determined for when said electronic monitoring device or GET with electronic monitoring device changes its metallic environment due to an installation/re-installation or detachment/removal event of an electronic monitoring device in a GET, said first twin of said sensing means being used, or the installation/re-installation or detachment/removable installation of a GET with electronic monitoring device with respect to a clamping element, using said second twin of said sensing means, the initial resonant frequency of the self-resonant RLC circuit being recorded, prior to the installation events of both said electronic monitoring device in a GET and said GET with electronic monitoring device with respect to a clamping element, and wherein said initial recorded resonant frequency is used to detect changes in the surrounding metallic environments; and, if said resonant frequency value increases by at least 3% from the initial recorded value prior to the event, it is determined that an installation/re-installation event of said electronic monitoring device in the GET, or of said GET with electronic monitoring device with respect to a fastener, has occurred; and, if with said electronic monitoring device or said GET with electronic monitoring device installed with respect to a fixture, said resonant frequency value is equivalent to the initially recorded value, it is determined that a detachment/removal event of said electronic monitoring device in the GET or of said GET with electronic monitoring device with respect to a fixture has occurred; said resonance frequency values may vary according to the method of manufacturing of GET, by forging or casting, its chemical composition, and the distance at which said sensing means are facing said GET or clamping elements, therefore calibration curves are previously constructed for said resonance frequency value.

1. A highly metallic environment monitoring system, which allows autonomously tracking, detecting and reporting the installation/re-installation or detachment/removal of an electronic monitoring device in a GET and the installation/re-installation or detachment/removal of a GET with electronic monitoring device with respect to a clamping element in an earthmoving machine, throughout its useful life cycle, and also allows to recognize that the removal of the GET is temporary either by maintenance, repair or replacement, or definitive either by discarding, because it was not recovered, or because the battery ran out or wireless communication was lost, allowing power management, wireless communication and detection based on 4 main operating states: “Standby” or simply “Standby” state where the electronic monitoring device, with power source installed, is not installed in a GET; “Device Installed” or simply “Device Installed” state where the electronic monitoring device is installed/re-installed in a GET; “GET Installed” or simply “GET Installed” state where a GET with electronic monitoring device is installed/re-installed in a machine fastener element; “GET Installed” or simply “GET Installed” state where a GET with electronic monitoring device is installed/re-installed in a machine fastener element; “GET Installed” or simply “GET Installed” state where a GET with electronic monitoring device is installed/re-installed on a fastening element of an earthmoving machine; or “GET Detached” or simply “GET Detached” status where a GET with electronic monitoring device is installed/re-installed on a fastening element of an earthmoving machine, in operation, the battery is dead or communication is lost, comprising:
a) at least one electronic monitoring device including at least one sensor node which is installed in at least one GET, and is located in a cavity (11) of said GET, in front of its fastening element, where it is not exposed to abrasion from the environment, and monitors said GET autonomously, sending data/information of the operation status of the life cycle to a “Gateway” according to wireless communication protocols according to one of the 4 aforementioned states, programmed into said electronic monitoring device managing the power consumption of the power source according to one of the 4 aforementioned states programmed into said electronic monitoring device and detecting installation/re-installation or detachment/removal according to one of the 4 aforementioned states programmed into said electronic monitoring device;
b) at least one central wireless communication coordination equipment or “Gateway” operating in star-type or mesh-type topology, or both, as a coordination mode of such wireless communication according to the wireless communication protocols programmed in the electronic monitoring device; and
c) at least one server corresponding to a computer equipment connected to a local network or the Internet, which stores, organizes and consults data/information from each of the media comprising an electronic monitoring device, and equipment operating in the network, including gateways, routers, cloud, servers with Internet connection.

2. The monitoring system of claim 1 wherein said “Gateway” is located at each location/location associated with said 4 lifecycle operating states.

3. The monitoring system of claim 2 wherein said “Gateway” is located on the cab roof or mast/arm of said earthmoving machine.

4. The monitoring system of claim 1 wherein said “Gateway” can establish wireless communication using complementary protocols selected from one or more of: “WIFI” to create local wireless communication networks between the “Gateways” and establish wireless communication with user interfaces; or Lora at 915 MHz, 868 MHz or 433 MHz, to communicate with different “Gateways” as well as cellular communication modules either 3G, 4G, 5G or 6G that allow access to the Internet, and with it, a direct connection to the cloud or to physical servers with Internet access that can in turn connect to the cloud.

5. The monitoring system of claim 1 wherein said “Gateways” further comprise a radionavigation or positioning (GPS) system that allows establishing the global position of said plurality of “Gateways” and, consequently, of the electronic monitoring devices connected to said plurality of “Gateways”.

6. The monitoring system of claim 1 further comprising at least one module or portable equipment for scanning an electronic monitoring device in “GET Detached” state which may have the same attributions of a “Gateway”, i.e. wireless communication, Internet connection, connection to the network of electronic monitoring devices, a computing or processing unit capable of receiving, processing and sending data/information from one network to another.

7. The monitoring system of claim 6 wherein said at least one module or portable scanning equipment establishes wireless communication with said detached GET according to the corresponding wireless communication protocol.

8. The monitoring system of claim 7 wherein said portable equipment for scanning establishes communication with the “Lora Ranging Engine Packet” protocol.

9. The monitoring system of claim 1 further comprising means for activating or enabling the generation of visual signals, auditory signals or both, wherein said means for activating or enabling the generation of visual signals, auditory signals or both are selected from visual or auditory signal emitting means selected from sirens, horns, speakers, loudspeakers, computer screens or wireless devices with digital display, with access to a telephone or satellite network and the Internet, wherein said visual signals are selected from text notes, images or both.

10. The monitoring system of claim 9 wherein said visual alarms, audible alarms, or both, are generated or sent, autonomously, either to an operator of the earthmoving machine or at a central monitoring station with a server connected to the network and which is located at the place of operation of the earthmoving machine or both.

11. The monitoring system of claim 10 wherein said audible signal, message with a text notification or both are displayed on a screen of a computer, cell phone or Tablet.

12. The monitoring system of claim 1 wherein said GET is selected from one or more teeth, adapters or protectors, shrouds, sidebar protectors or teeth holders.

13. The monitoring system of claim 1 wherein said fastening element is selected from an adapter, bucket lip or bucket.

14. The monitoring system of claim 1 wherein said clamping element and said GET may be the same when said clamping element protects said lip and bucket of said earthmoving machine.

15. The monitoring system of claim 1 wherein said clamping element is an adapter that clamps the tooth, and further protects the lip from wear, impact and shock.

16. The monitoring system of claim 1 wherein said earthmoving machine is selected from a mining shovel or mining loading equipment.
